(19) United States
(12) Patent Application Publication
(10) Pub. No.: US 2020/0206968 A1
(43) Pub. Date: Jul. 2, 2020

(54) WOOD SPLITTING AID

(71) Applicant: Nicholas Hysni Seed, Wasaga Beach (CA)

(72) Inventors: Nicholas Hysni Seed, Wasaga Beach (CA); Christopher J. Pearen, Brampton (CA); Shahram Nabavi, Richmond Hill (CA)

(73) Assignee: Nicholas Hysni Seed, Wasaga Beach (CA)

(21) Appl. No.: 16/815,058

(22) Filed: Mar. 11, 2020

Related U.S. Application Data
(63) Continuation-in-part of application No. 15/361,662, filed on Nov. 28, 2016, now Pat. No. 10,618,195.

(30) Foreign Application Priority Data
Nov. 26, 2015 (GB) 1520875.4

(51) Int. Cl. B27L 7/08

(52) U.S. Cl. CPC B27L 7/08

(57) ABSTRACT

A wood splitting aid and a method of use thereof. In one embodiment, the aid includes an upper receptacle positioned above a lower receptacle. A connector assembly secures the upper and lower receptacles together. A resilient member is provided on an upper end of a partially flexible side wall of the upper receptacle. Wood is placed within a cavity defined by the upper receptacle's side wall. When wood in the cavity is split by a chopping tool, force from the chopping tool is partially absorbed by the resilient member, is partially transferred to the flexible side wall, and subsequently transfers to the lower receptacle and then to the surface upon which the aid rests. An enlarged diameter base is engaged with the lower receptacle if the aid is to sit on soft ground. An adjustable base is engaged with the lower receptacle when the aid is placed on inclined ground.

### CROSS REFERENCE TO RELATED APPLICATIONS

This application is a Continuation-in-Part of U.S. patent application Ser. No. 15/361,662 filed Nov. 28, 2016, the disclosure of which is incorporated herein by reference. U.S. patent application Ser. No. 15/361,662 claims priority from GB 1520875.4, filed Nov. 26, 2015.

### TECHNICAL FIELD

This disclosure is generally directed to articles and equipment used to chop wood. More particularly, this disclosure relates to equipment that is used when and chopping pieces of firewood into kindling. Specifically, the disclosure is directed to a wood splitting aid in which a piece of previously cut firewood is placed for chopping into kindling, which aid holds the piece of firewood at a more comfortable height for chopping and which will capture the kindling produced when the firewood is chopped.

### BACKGROUND

### Background Information

Man has been chopping wood into smaller pieces to make fires for millennia. Typically, a tree trunk or branch is cut transversely into sections. The transversely cut sections may then be split longitudinally one or more times to produce pieces of wood that are of a suitable size for use as firewood. The transversely cut sections are typically split longitudinally by placing one end thereof on a supportive surface, such as on the ground. The uppermost end of the wood section is struck from above with a sharpened heavy blade, such as by an ax, a maul, or a wedge, so as to create a lengthwise crack. In some instances, the original piece of wood will split apart along the crack into smaller pieces but in other instances the crack has to be widened in order to split the wood into pieces.

Larger diameter pieces of wood may need to be split multiple times in order to produce usable size firewood. These larger diameter pieces of wood can be difficult to split, particularly if the wood is hard. Sometimes, instead of creating a crack and splitting the wood section, the blade of the ax becomes stuck part way. One strategy for splitting the wood section when this happens involves swinging the ax and wood section upwardly and then driving the same downwardly to cause the lower end of the wood section to strike the ground. This action can cause the ax blade to move downwardly through the wood, widening the initial crack to the point that the wood splits apart. This action may have to be repeated a number of times. Another effective strategy is to wedge the blade of the ax into the end of the large diameter piece of wood and then and strike the head or end of the ax with another tool in order to drive the ax blade downwardly through the piece of wood

Problems and safety issues arise as the pieces of wood being chopped from the original transversely cut section become smaller and smaller, particularly if the person is trying to produce kindling. The issues arise because smaller pieces of wood tend to become more difficult to stand on one end and are more difficult to chop squarely with the sharpened blade. The smaller wood pieces require less force to split but because they are vertically unstable, there is a temptation to try and hold the smaller piece upright with one hand. The person may then try and swing the ax with the other hand and then release the piece of wood just before the ax strikes the same. Obviously, this is an unsafe way of producing kindling and can lead to the person seriously hurting themselves. In some instances, the person will try to rest the smaller piece of wood against some type of vertically oriented support like another log or a chopping block. Trying to support the smaller piece of wood in this way can result in the ax not striking the wood truly and splitting the same. Instead, smaller pieces may fly off the piece being cut and hurt the person chopping the wood or persons nearby.

### SUMMARY

There is therefore a need in the art for a safer way to chop wood. In particular, there is a need for a safer way to chop kindling. The wood splitting aid disclosed herein provides a way to support a piece of wood while being chopped and prevents smaller pieces from flying outwardly and hurting people nearby.

It is an object of the invention to provide an inexpensive portable tool set to be readily kept at the site of chopping or splitting firewood for kindling purposes which assists in maintaining high safety standards, which provides additional protection against missed swings and which provides for storage and transportation of individual kindling pieces within the tool set plus ready storage of the tool set when not in use.

It is a further object of the invention to provide a tool set which readily confines wood pieces vertically during kindling or splitting production and which provides a sturdy chopping base without cumbersome binding restraints or clamps which would absorb impact energy.

It is a further object of the invention to provide a tool set which maintains traditional vertical work piece positioning of a plurality of work pieces as a group, traditional swing positioning (vertical motion at point of impact) and traditional impact energy distribution, while preventing fly off of cut pieces of kindling.

It is a further object of the invention to provide a tool set adapted for use with irregularly cut work pieces which would not stand vertically atone, either before or after cutting.

It is a further object of the invention to provide for simple and inexpensive manufacturing by the use of common molds and reduced shipping volumes.

It is a still further object of the invention to provide a tool set wherein the upper receptacle retains the cut kindling product for transportation and, upon completion of the work, is adapted to nest the lower or other receptacle for convenient storage and transportation.

It is a yet still further object of the invention to provide a kindling tool set which is simple to manufacture, long lasting, weatherproof and readily usable in all manner of conditions including cold and heat, which is light weight in use and transportation, which is simple to assemble and dissemble in seconds despite the conditions, and which is convenient to use and to store in a modern household environment.

A wood splitting aid and a method of use thereof is disclosed herein. The aid includes an upper receptacle positioned above a lower receptacle. A connector assembly secures the upper and lower receptacles together. A resilient member is provided on an upper end of a partially flexible side wall of the upper receptacle. Wood is placed within a cavity defined by the upper receptacle's side wall. When wood in the cavity is split by a chopping tool, force from the chopping tool is partially absorbed by the resilient member, is partially transferred to the flexible side wall, and subsequently transfers to the lower receptacle and then to the surface upon which the aid rests. An enlarged diameter base is engaged with the lower receptacle if the aid is to sit on soft ground. An adjustable base is engaged with the lower receptacle when the aid is placed on inclined ground.

In one aspect, an exemplary embodiment of the present disclosure may provide a wood splitting aid comprising a receptacle having a bottom wall and a side wall extending upwardly from the bottom wall; an interior cavity bounded and defined by the bottom wall and the side wall, wherein the interior cavity is adapted to receive a piece of wood to be split therein; and a resilient member provided on an upper end of the side wall of the upper receptacle.

In one aspect, an exemplary embodiment of the present disclosure may provide a wood splitting aid comprising an upper receptacle having a bottom wall and a side wall extending upwardly from the bottom wall; an interior cavity bounded and defined by the bottom wall and the side wall, wherein the interior cavity is adapted to receive a piece of wood to be split therein; a lower receptacle positionable below the bottom wall of the upper receptacle; a connector assembly that secures the upper receptacle and lower receptacle to each other at least temporarily; and a resilient member provided on an upper end of the side wall of the upper receptacle.

In one embodiment, the resilient member may encircle an opening to the interior cavity. In one embodiment, the resilient member may be fabricated from rubber. In one embodiment, the resilient member may be reinforced with metal. In one embodiment, the side wall of the upper receptacle may include a lower section extending upwardly from the bottom wall, and an upper section extending upwardly from the lower section; and wherein one of the upper section and lower section is fabricated from a flexible material and the other of the upper section and lower section is fabricated from a rigid material. In one embodiment, the flexible material and rigid material may be co-molded. In one embodiment, the flexible material may join the rigid material along a join region. In one embodiment, the join region is in a configuration of a sinuous wave. In another embodiment, the join region may be a generally straight line. In yet other embodiments, the join region may be of any other desired configuration other than a sinuous wave or a straight line.

In one embodiment, the wood splitting aid may define one or more apertures defined in the side wall of the upper receptacle. In one embodiment the one or more apertures may be defined in a region of the side wall proximate the bottom wall. In one embodiment, the wood splitting aid may further comprise a restraint adapted to secure a part of an ax handle against the resilient member. In one embodiment, the restraint may include a first portion that engages the resilient member and a second portion that is adapted to engage the ax handle. In one embodiment, the second portion is a tether that is secured to the first portion at a first end and is selectively secured to the first portion at a second end. In one embodiment, the resilient member may be cylindrical and a seat may be defined in an upper surface of the resilient member and the seat may be adapted to receive a portion of an ax handle therein; and wherein the restraint comprises a tether that extends outwardly from a first region of the resilient member and is engageable with a second region of the resilient member. In one embodiment, the restraint may comprise a pair of spaced apart holes defined in the side wall of the upper receptacle; and an elastic cord having hooks at either end; wherein each hook may be selectively engageable in one of the holes of the pair of holes. In one embodiment, the second portion may comprise a tether.

In one embodiment, the wood splitting aid may further comprise a base selectively engageable with a lowermost end of the lower receptacle; wherein the base is of a greater diameter than the lowermost end of the lower receptacle. In one embodiment, the wood splitting aid may further comprise an adjustment base that comprises a first base section having a side wall that tapers in height, and the first base section may be engageable with a lowermost end of the lower receptacle, wherein the first base section is relative to the lower receptacle. In one embodiment, the adjustment base may further comprise a second base section having a side wall that tapers in height; wherein the second base section is engageable with a bottom region of the first base section. In one embodiment the second base section may be rotatable relative to the first base section.

In one embodiment, the wood splitting aid may further comprise a rain bib that is selectively engageable with the upper receptacle to temporarily close off access to the interior cavity. The rain bib is engaged with the wood splitting aid to prevent rain, snow, dirt, leaves, etc. from accumulating in the interior cavity. In one embodiment, the wood splitting aid may further comprise a liner that is selectively positionable within the interior cavity to line the same.

In another aspect, an exemplary embodiment of the present disclosure may provide a method of splitting wood comprising providing a receptacle that defines an interior cavity; providing a resilient member of the wood splitting aid on an upper end of the receptacle; placing a piece of wood into a cavity bounded and defined by a side wall of the receptacle; striking the piece of wood with a blade of a chopping tool; splitting the piece of wood into smaller pieces of wood; and absorbing some of a force generated by striking the piece of wood with the chopping tool with the resilient member.

In another aspect, an exemplary embodiment of the present disclosure may provide a method of splitting wood comprising placing a lower receptacle of a wood splitting aid on a flat surface; placing an upper receptacle of the wood splitting aid onto a top end of the lower receptacle; engaging a connector assembly of the wood splitting aid to secure the upper receptacle and lower receptacle together; providing a resilient member of the wood splitting aid on an upper end of the upper receptacle; placing a piece of wood into a cavity bounded and defined by a side wall of the upper receptacle; striking the piece of wood with a blade of a chopping tool; splitting the piece of wood into smaller pieces of wood; and absorbing some of a force generated by striking the piece of wood with the chopping tool with the resilient member.

In one embodiment, the method may provide transferring some of the force generated by striking the piece of wood from the resilient member to a flexible portion of the side wall of the upper receptacle. In one embodiment, the method may provide transferring some of the force from the side wall of the upper receptacle to a rigid sidewall of the lower receptacle. In one embodiment, the method may provide transferring some of the force from the rigid sidewall of the lower receptacle to the flat surface.

In one embodiment, the method may provide containing the smaller pieces of firewood in the cavity of the upper receptacle. In one embodiment, the engaging of the connector assembly includes aligning tabs on the bottom wall of the upper receptacle with flanges on a collar that extends around an exterior surface of a bottom end of the upper receptacle and a top end of the lower receptacle. In one embodiment, the aligning includes rotating the collar about the exterior surface of the bottom end of the upper receptacle and the top end of the lower receptacle. In one embodiment, the method may provide removing bark and shards of wood generated by splitting the wood from the cavity through at least one aperture defined in a side wall of the upper receptacle.

In one embodiment, the method may provide placing a section of a handle of the chopping tool on the resilient member; wrapping a tether over a top of the handle; and securing the tether to one of the side wall of the upper receptacle or to the resilient member. In one embodiment, the method may provide positioning a blade of the chopping tool on the piece of wood; striking a head of the chopping tool with a heavy object; and driving the blade into the piece of wood.

In one embodiment, the method may provide engaging a base with a lower end of the lower receptacle, wherein the base is of a greater diameter than the lower end of the lower receptacle; and placing a bottom surface of the base on the flat surface; wherein the base is engaged with the lower receptacle when the flat surface is a soft surface.

In one embodiment, the method may provide engaging a first base section of an adjustable base with a lower end of the lower receptacle; rotating a second base section of the adjustable base relative to the first base section; changing an angle of a bottom surface of the second base surface relative to the lower end of the lower receptacle; and placing the bottom surface of the second base section on an inclined flat surface.

In one embodiment, the method may provide engaging a rain bib over an upper end of the upper receptacle for storage; and removing the rain bib to use the wood splitting aid. In one embodiment, the method may provide placing a liner around an interior surface of the wood splitting aid that defines the cavity prior to placing the piece of wood into the cavity. In one embodiment, the method may further provide removing the liner with the smaller pieces of wood therein from the cavity of the upper receptacle.

### BRIEF DESCRIPTION OF THE SEVERAL VIEWS OF THE DRAWINGS

A sample embodiment of the disclosure is set forth in the following description, is shown in the drawings and is particularly and distinctly pointed out and set forth in the appended claims. The accompanying drawings, which are fully incorporated herein and constitute a part of the specification, illustrate various examples, methods, and other example embodiments of various aspects of the disclosure. It will be appreciated that the illustrated element boundaries (e.g., boxes, groups of boxes, or other shapes) in the figures represent one example of the boundaries. One of ordinary skill in the art will appreciate that in some examples one element may be designed as multiple elements or that multiple elements may be designed as one element. In some examples, an element shown as an internal component of another element may be implemented as an external component and vice versa. Furthermore, elements may not be drawn to scale.

FIG. 1 is a top perspective view of a first embodiment of a wood splitting aid in accordance with an aspect of the present disclosure;

FIG. 2 is a bottom perspective view of the wood splitting aid of FIG. 1;

FIG. 3 is a front elevation view of the wood splitting aid;

FIG. 4 is a longitudinal cross section of the wood splitting aid taken along line 4-4 of FIG. 3;

FIG. 5 is a side elevation view of the wood splitting aid;

FIG. 6 is a bottom plan view of the wood splitting aid

FIG. 7 is a top plane view of the wood splitting aid;

FIG. 8 is an exploded top perspective view of the wood splitting aid;

FIG. 9 is an exploded bottom perspective view of the wood splitting aid;

FIG. 10 is a top perspective view of the wood splitting aid in use;

FIG. 11 is a top perspective view of a second embodiment of a wood splitting aid in accordance with the present disclosure shown in use;

FIG. 12 is a side elevation view of the wood splitting aid of FIG. 11 showing that the ax handle restrained by a restrained and showing how the ax blade may be moved downwardly and the ax handle may be moved upwardly to split the wood;

FIG. 13 is a top perspective view of the wood splitting aid of FIG. 12 in use;

FIG. 14 is a side elevation view of a third embodiment of a wood splitting aid in accordance with an aspect of the present disclosure shown in use;

FIG. 15 is a top perspective view of the wood splitting aid of FIG. 14 shown in use;

FIG. 16 is a top perspective view of the wood splitting aid of FIG. 15 shown in use;

FIG. 17 is a top perspective view of a fourth embodiment of a wood splitting aid in accordance with an aspect of the present disclosure;

FIG. 18 is an exploded top perspective view of the wood splitting aid of FIG. 17;

FIG. 19 is a side elevation view of the wood splitting aid of FIG. 17;

FIG. 20 is a top perspective view of a fifth embodiment of a wood splitting aid in accordance with an aspect of the present disclosure;

FIG. 21 is a partial, exploded, top perspective view of the wood splitting aid of FIG. 20;

FIG. 22 is a side elevation view of the wood splitting aid of FIG. 20 shown resting on a level surface;

FIG. 23 is a side elevation view of the wood splitting aid of FIG. 20 shown resting on an inclined surface, where the inclined surface is at a first angle;

FIG. 24 is a side elevation view of the wood splitting aid of FIG. 20 shown resting on an inclined surface, where the inclined surface is at a second angle;

FIG. 25 is a top perspective view of a sixth embodiment of a wood splitting aid in accordance with an aspect of the present disclosure showing a rain bib covering the upper receptacle;

FIG. 26 is a top perspective view of the wood splitting aid of FIG. 25 shown in use;

FIG. 27 is a top perspective view of a seventh embodiment of a wood splitting aid in accordance with an aspect of the present disclosure shown in use;

FIG. 28 is a top perspective view of the wood splitting aid of FIG. 27 shown in use;

FIG. 29 is a top perspective view of an eighth embodiment of a wood splitting aid in accordance with an aspect of the present disclosure;

FIG. 30 is a side elevation view of the wood splitting aid FIG. 29;

FIG. 31 is a top perspective view of the wood splitting aid of FIG. 29 shown in use; and

FIG. 32 is a top perspective view of the wood splitting aid of FIG. 29 shown in use.

Similar numbers refer to similar parts throughout the drawings.

### DETAILED DESCRIPTION

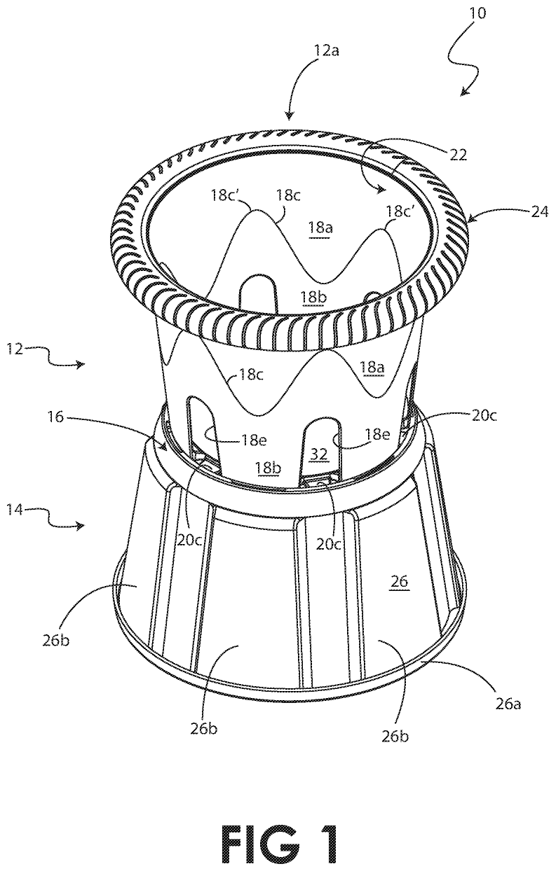

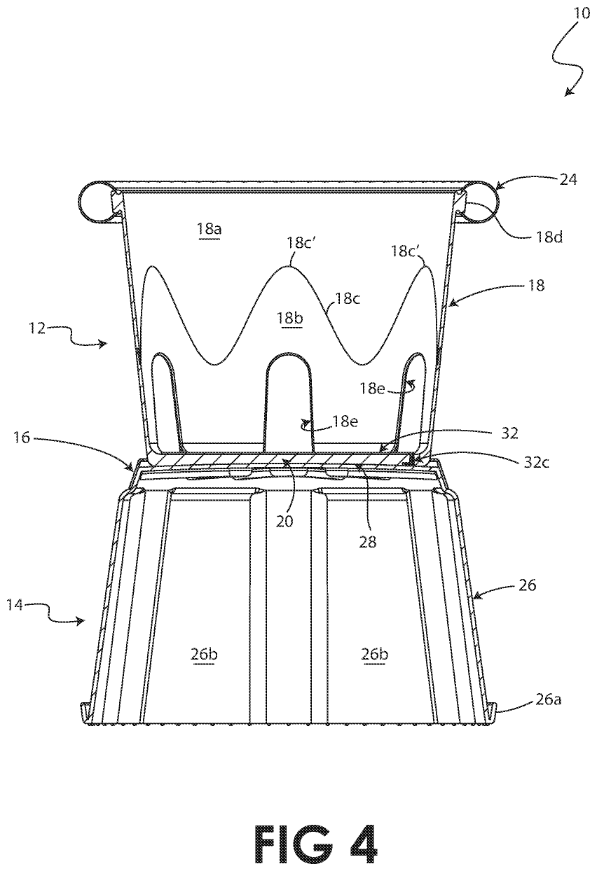

Referring to FIGS. 1-9, there is shown a first embodiment of a wood splitting aid in accordance with an aspect of the present disclosure, generally indicated at 10. Wood splitting aid 10 will be referred to hereafter as “aid 10”.

Aid 10 comprises an upper receptacle 12 and a lower receptacle 14 that are releasably engaged with each other by way of a connector assembly 16. Connector assembly 16 helps to interlock upper receptacle 12 with lower receptacle 14 and to stop the upper and lower receptacles from bouncing about relative to each other when firewood is being split within aid 10. Each of the upper receptacle 12, lower receptacle 14, and connector assembly 16 will be described in greater detail hereafter.

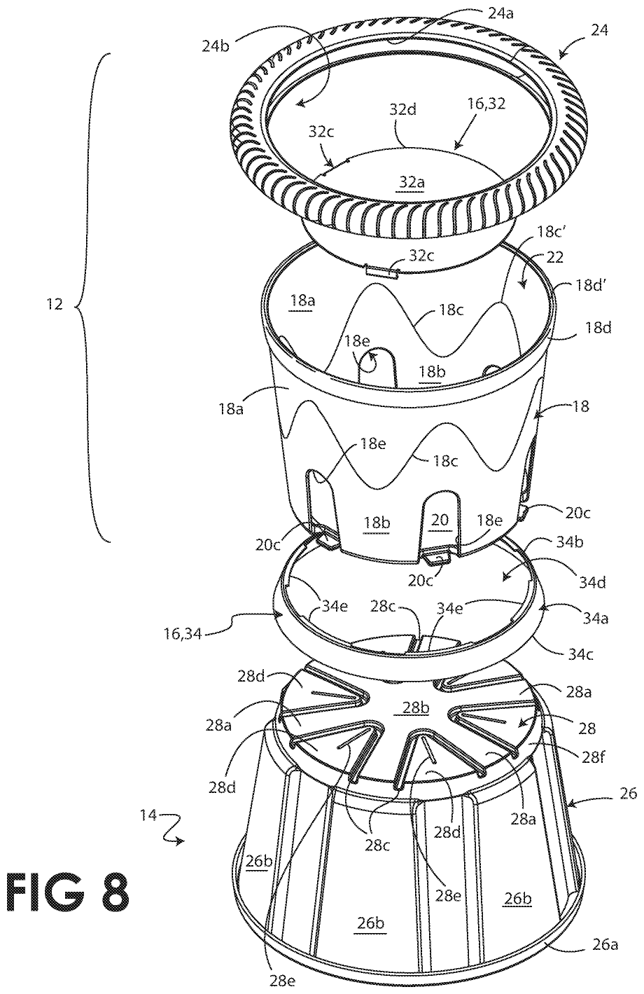

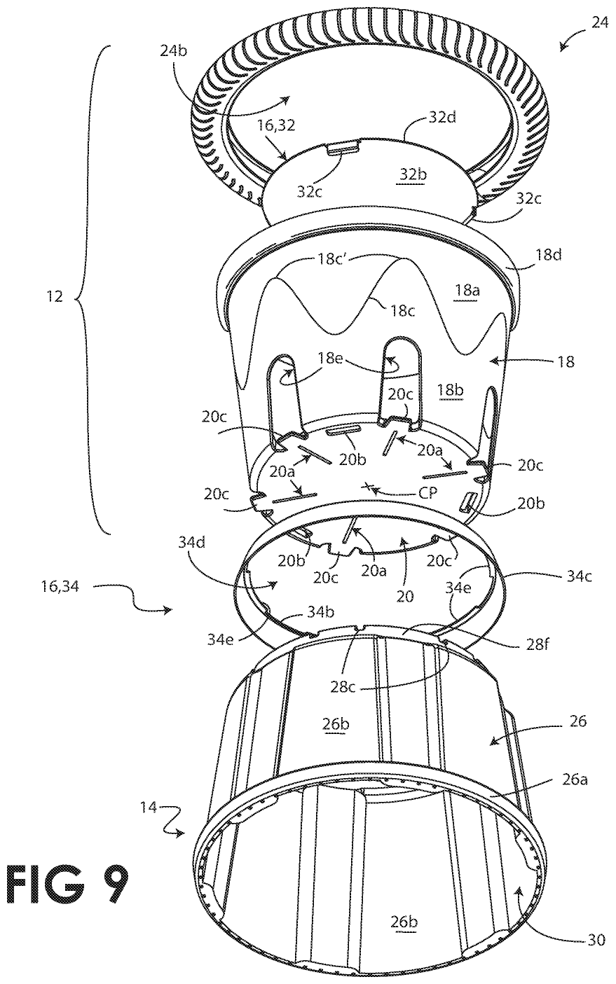

Referring to FIGS. 8 and 9, upper receptacle 12 includes a side wall 18 that extends upwardly and outwardly from a bottom wall 20. Side wall 18 and bottom wall 20 bound and define an interior cavity 22 that is accessible through an opening defined in an upper end 12a of upper receptacle 12. Side wall 18 comprises an upper section 18a and a lower section 18b. Lower section 18b is connected to a peripheral edge of bottom wall 20. Upper and lower sections 18a, 18b of side wall 18 are comprised of co-molded material and have different properties from each other. Lower section 18b and bottom wall 20 are molded from a substantially rigid material while upper section 18a is molded from a material that is more flexible or resilient than the material of lower section 18b. Upper section 18a and lower section 18b are joined or molded together along a join region 18c that is shaped as a sinuous wave. As will be explained later herein, upper section 18a may experience shockwaves that are caused by blows from an ax or other cutting implement. The circumferential wavelike configuration of join region 18c may help to disperse these shockwaves from the upper section 18a into the lower section 18b and thereby into the lower receptacle 14.

It will be understood that in other embodiments, instead of the joint region 18c being in the form of a sinuous wave, the join region may be a straight line. In yet other embodiments, the join region may be in any other desired configuration.

It will be understood that in other embodiments, the lower section 18b may be fabricated from the flexible or resilient material and the upper section 18a may be fabricated from the rigid material. In these embodiments, the bottom wall 20 will be fabricated from a rigid material.

Side wall 18 also includes an annular rim 18d (FIG. 8) that is at an uppermost end of upper region 18a, i.e., remote from bottom wall 20. Annular rim 18d is generally oriented horizontally and extends outwardly for a distance beyond upper and lower sections 18a, 18b of side wall 18. An interior region of rim 18d may be chamfered as at 18d′. Additionally, side wall 18 tapers from rim 18d downwardly towards bottom wall 20.

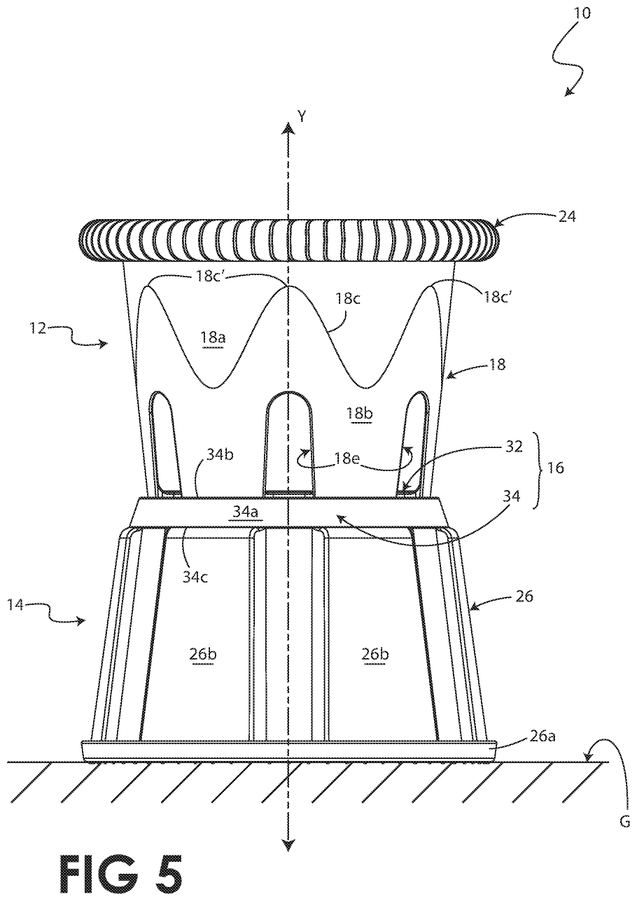

A plurality of inverted, U-shaped apertures 18e are defined in lower section 18b of side wall 18. Apertures 18e are provided to allow for bark, wood shards and smaller to be cleared out of upper receptacle 12 after firewood has been split therein. Each aperture 18e originates proximate bottom wall 20 and extends upwardly for a distance into lower section 18b. Each aperture 18e extends from an outer surface of lower section 18b to an inner surface thereof. Apertures 18e are therefore in fluid communication with interior cavity 22. Apertures 18e are spaced at regular intervals around the circumference of lower section 18b and extend longitudinally alongside wall, i.e., generally parallel to a central, longitudinal axis “Y” (FIG. 5). In particular, each aperture 18e is generally located within an area of lower section 18b that falls under a peak 18c′ of the wavelike region 18c.

Referring particular to FIG. 9, bottom wall 20 defines a plurality of first slots 20a, second slots 20b, and tabs 20c. First slots 20a and second slots 20b extend between an interior surface of bottom wall 20 and an exterior surface thereof and are thus in fluid communication with interior cavity 22. First slots 20a originate a distance outwardly from a center point “CP” of bottom wall and extend radially outwardly therefrom. First slots 20a are spaced at regular intervals from each other. Each first slot 20a is aligned with a central region of one of the apertures 18e. As illustrated in the attached figures, particularly FIG. 7, there are six apertures 18e defined around the circumference of lower section 18b of side wall 18. FIG. 9 shows that there are a complementary number of six first slots 20a defined in bottom wall 20 (one of the first slots 20a being hidden behind the collar of the connector assembly 16.

Each second slot 20b is arranged generally parallel to and inwardly from a circumferential outer edge of bottom wall 20. Each second slot 20b is located generally equidistantly between two adjacent apertures 18e. There are only three second slots 20b defined in bottom wall 20. Consequently, there are three sets of adjacent apertures 18e that do not have a second slot 20b defined in the bottom wall 20 between them. The second slots 20b are arranged at about 120° from each other around the circumference of the bottom wall 20. This arrangement can most readily be seen in FIG. 7.

Each tab 20c is aligned centrally within one of the apertures 18e of side wall and extends radially outwardly from the circumferential outer edge of bottom wall 20 and into the associated aperture. This is readily seen in FIG. 7. Each of the first slots 20a is radially aligned with one of the tabs 20c and one of the apertures 20c.

It will be understood that in other embodiments, less than six apertures 18e or more than six apertures 18e may be provided in upper receptacle 12. A complementary number of less than six first slots and less than six tabs 20c or more than six first slots 20a and more than six tabs 20c may be provided in these other embodiments of wood splitting aids. Still further, less than three second slots 18b or more than three second slots 18b may be provided in other embodiments of wood splitting aids.

In accordance with an aspect of the present disclosure a resilient member 24 is engaged with upper receptacle 12. Resilient member 24 may be comprised of a rubber tire that is secured to rim 18d. In particular, the rubber tire may be a reinforced radial tire that includes woven or metal reinforcing. Resilient member 24 is therefore suitable for receiving blow or strike thereon and absorbing the same without becoming damaged.

Resilient member 24 may include a circumferential slot 24a (FIG. 8) into which rim 18d is received. Resilient member 24 may be retained on rim 18d by friction or by an adhesive, heat welding, or fasteners. Any suitable way of securing resilient member 24 to upper receptacle 12 may be employed. In other embodiments, resilient member 24 may rest on top of an uppermost surface of rim 18d and may be secured thereto in an appropriate way such as through use of an adhesive, heat welding or fasteners. Resilient member 24 defines an opening 24b that aligns with the opening to interior cavity 22 of upper receptacle 12. Interior cavity 22 is thus accessible through the opening 24b of resilient member 24 when resilient member 24 is engaged with upper receptacle 12. The purpose of resilient member 24 will be described later herein.

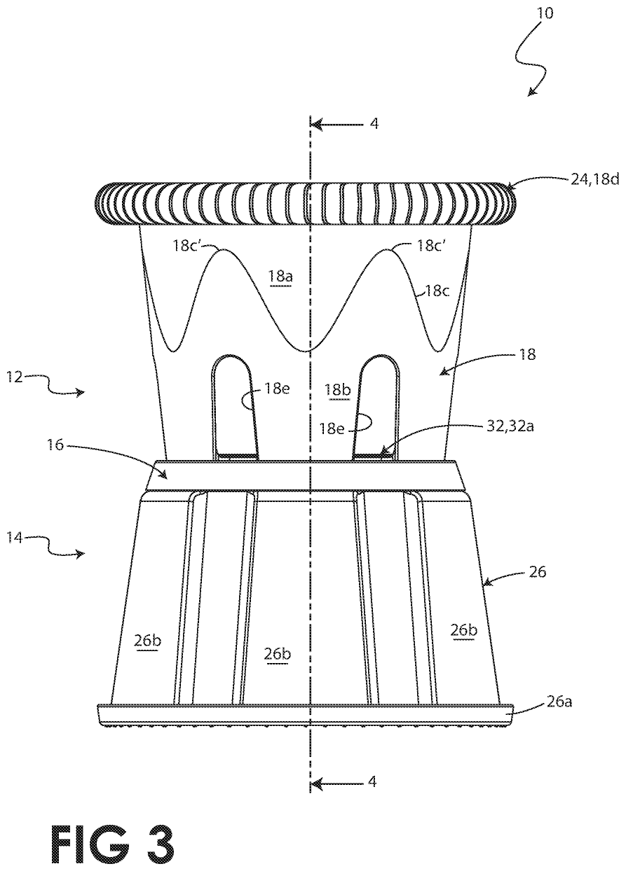

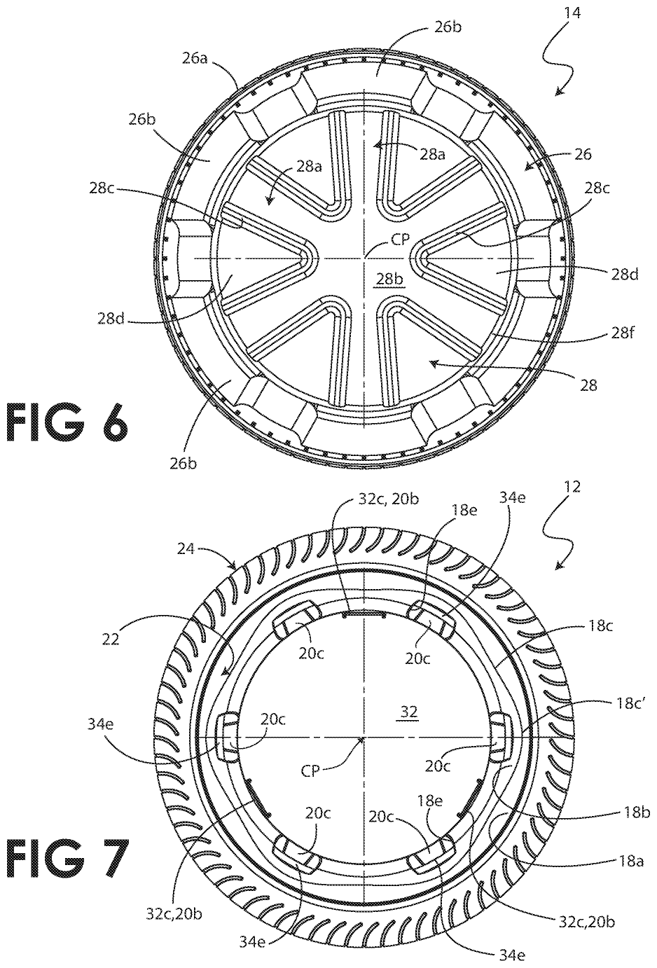

Referring to FIGS. 6, 8 and 9, lower receptacle 14 includes a side wall 26 and a top wall 28. Side wall 26 and top wall 28 bound and define an interior chamber 30 (FIG. 9) that is accessible through an opening defined by a lowermost rim 26a provided on side wall 26. Rim 26a preferably comprises a reinforced annular ring that extends for a short distance upwardly and outwardly beyond the rest of side wall 26. Side wall 26a tapers from rim 26a towards top wall 28. As is shown in FIG. 3, lower receptacle 14 preferably is of a greater diameter proximate connector assembly 16 than is upper receptacle. Furthermore, lower receptacle 14 preferably is of a greater diameter proximate rim 26a than is upper receptacle 12 proximate rim 18d and resilient member 24.

A plurality of reinforcing ribs 26b are provided at intervals around the circumference of side wall 26 of lower receptacle 14. When upper and lower receptacles 12, 14 are engaged with each other, as will be described below, each reinforcing rib 26b is generally aligned with a portion of lower section 18b that extends between adjacent apertures 18e defined in upper receptacle 12.

Top wall 28 is also provided with a plurality of reinforcing ribs 28a that extend radially outwardly from a reinforced central region 28b to form a star-shaped pattern (FIG. 6). V-shaped grooves 28c separate adjacent ribs 28a from each other. A V-shaped pad 28d is provided between each set of adjacent ribs 28. A bumper 28e is provided on an upper surface of each pad 28d. The bumper 28e extends radially outwardly from proximate an apex of the V-shape. Bumpers 28e are generally vertically aligned with first slots 20a defined in bottom wall 20 of upper receptacle 12. Each bumper 28e aligns with and engages with one of the first slots 20a defined in a lowermost surface of bottom wall 20. The bumpers 28e and slots 20a are used as a type of locator for correctly positioning upper receptacle 12 on lower receptacle 14.

As best seen in FIGS. 8 and 9, a circumferential outer edge 28f of top wall 28 is recessed relative to side wall 26. Outer edge 28f is inclined at an angle, being of a smaller circumference proximate an upper surface of top wall 28 and of a larger circumference proximate side wall 26.

Referring to FIGS. 8 and 9, connector assembly 16 comprises a connector plate 32 and a connector collar 34. Connector plate 32 is a circular, flat plate that is of generally a similar size to bottom wall 20 of upper receptacle 12. Plate 32 preferably is fabricated from a strong, rigid material such as metal. Plate 32 is provided as a suitable surface upon which to rest a piece of firewood to be split.

Plate 32 has an upper surface 32a (FIG. 8) a lower surface 32b (FIG. 9). A plurality of detents 32c extend downwardly below lower surface 32b from a circumferential edge 32d of plate 32. As illustrated, plate 32 includes three detents 32c that are spaced at about 120° relative to each other about the circumference of plate 32. In particular, detents 32c are complementary to second slots 20b defined in bottom wall 20. In other words, detents 32c are spaced, shaped, and sized to be received through second slots 20b of bottom wall 20. Connector plate 32 is inserted into interior cavity 22 of upper receptacle 12 and is moved downwardly until lower surface 32b thereof rests on an upper surface of bottom wall 20 and detents 32c are received through second slots 20b. Plate 32 thus forms the bottom interior surface of upper receptacle 12 and upper surface 32a of plate 32 is the surface upon which firewood will ultimately rest when aid 10 is used.

Referring to FIGS. 5, 8, and 9, collar 34 comprises an annular ring 34a that has an upper edge 34b and a lower edge 34c. Upper edge 34b is of a smaller circumference relative to lower edge 34c. Annular ring 34a is thus oriented at an angle. In particular, the angle of annular ring 34a is complementary to the angle of outer edge 28f of lower receptacle 14. An interior surface of annular ring 34 bounds and defines a central opening 34d. A plurality of flanges 34e (FIG. 8) extends inwardly from annular ring 34 into opening 34d. In particular, flanges 34e extend horizontally into opening 34d from upper edge 34b of ring 34. (It will be understood that in other embodiments the flanges may extend inwardly into opening 34d from lower edge 34c or from somewhere intermediate upper and lower edges 34b, 34c. Annular ring 34a preferably is provided with a number of flanges 34e that is complementary to the number of tabs 20a provided on bottom wall 20 of upper receptacle 12.

Aid 10 is set up for use by placing rim 26a of lower receptacle 26 on a flat surface, such as the ground “G” shown in FIG. 5. The open end of lower receptacle 14 thus faces the ground “G” and top wall 28 is spaced a distance above ground “G” and is generally parallel thereto. Collar 34 is slipped onto a lower end of upper receptacle 12 and then the user will then rotate one or both of collar 34 and upper receptacle 12 about longitudinal axis “Y” until flanges 34e on collar 34 are positioned vertically above tabs 20c on upper receptacle 12. This rotational motion causes collar 34 and upper receptacle 12 to be engaged with each other. (To disengage collar 34 from upper receptacle 12 the user simply has to rotate one or both of collar 34 and upper receptacle 12 so that flanges 34e no longer align with tabs 20c.)

Collar 34 is then placed over the upper end of lower receptacle 14. The complementary fit and angle of collar 34 and outer edge 28f of lower receptacle's top wall 28 causes collar to become frictionally engaged with lower receptacle 14.

Connector plate 32 may be interlockingly engaged with bottom wall 20 of upper receptacle 12 either before upper and lower receptacles 12, 14 are engaged with each other or after they are engaged with each other. Connector plate 32 reinforces bottom wall 20/top wall 28.

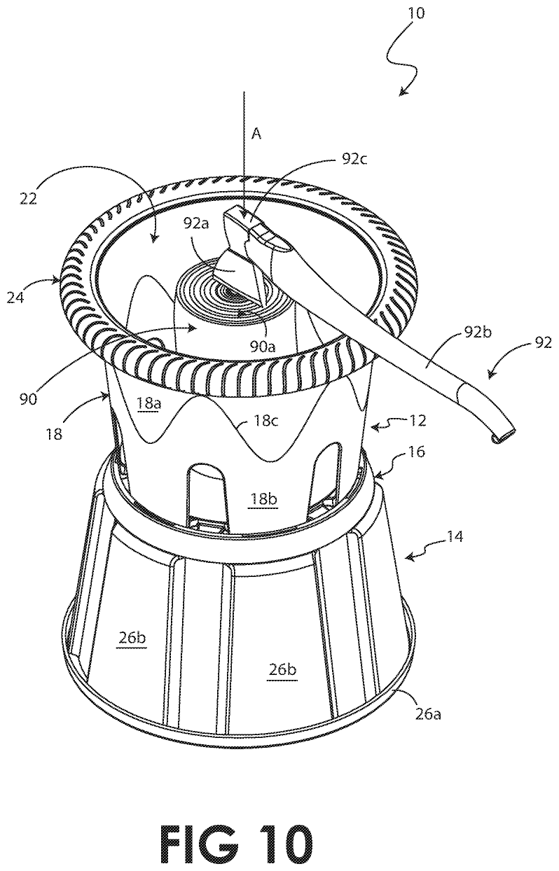

Referring to FIG. 10, wood splitting aid 10 is once upper receptacle 12 and lower receptacle 14 are engaged with each other and are resting on ground “G”, a piece of firewood 90 is introduced into interior cavity 22. In particular, a first end (not shown) of firewood 90 is rested on upper surface 32a of plate 32 and firewood 90 is oriented generally parallel to longitudinal axis “Y” (FIG. 5) of aid 10. A second end 90a of firewood 90 is presented for splitting. An ax 92 or other cutting implement is then utilized to split the firewood 90. In particular, the blade 92a of ax 92 is moved downwardly with force in the direction indicated by arrow “A” so that the edge of blade 92a is driven into second end 90a of the firewood 90. If during this downward strike, the handle 92b of ax 92 contacts resilient member 24, some of the impact of that blow on the upper receptacle 12 is at least partially absorbed by resilient member 24. The resilient upper section 18 of upper receptacle 12 will also help to absorb and disperse some of the impact force and transfer the rest to lower section 18b and subsequently to lower receptacle 14, and thereby to the ground “”G”. The resilience of resilient member 24 and upper section 18a of upper receptacle 12 helps to ensure that the upper receptacle 12 will tend to survive the impact intact. Additionally, the absorption and dispersion of the impact force helps to ensure that the shock is not transferred to the hands and arms of the person wielding the ax. The reinforcing ribs 26b, and reinforced areas 28a, 28b, 28d, help to ensure that lower receptacle 14 is able to withstand the impact of the ax 92 on firewood 90.

As the firewood 90 splits, some smaller pieces of wood may fly off the piece being split. Those smaller pieces will be contact the interior surface of side wall 18 and be retained within interior cavity 22. Some of the smaller pieces may ultimately drop out of the interior cavity 22 through apertures 18e.

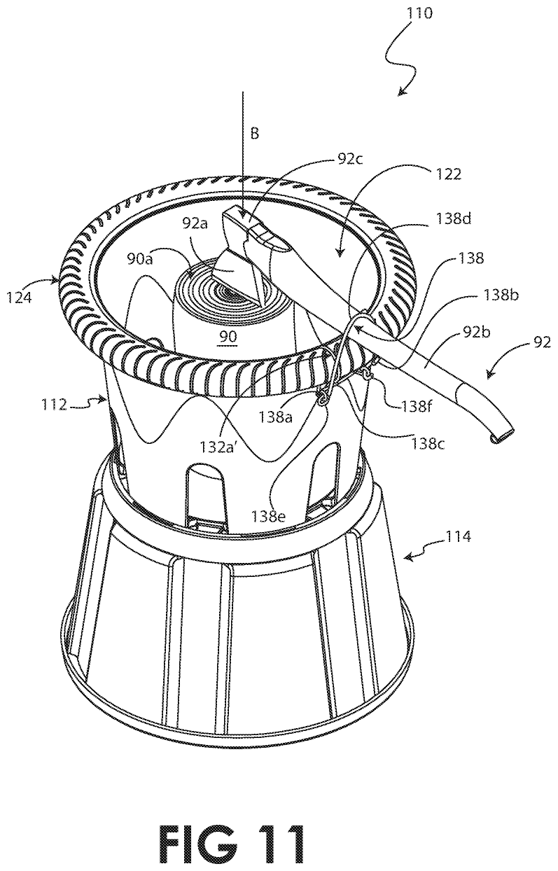

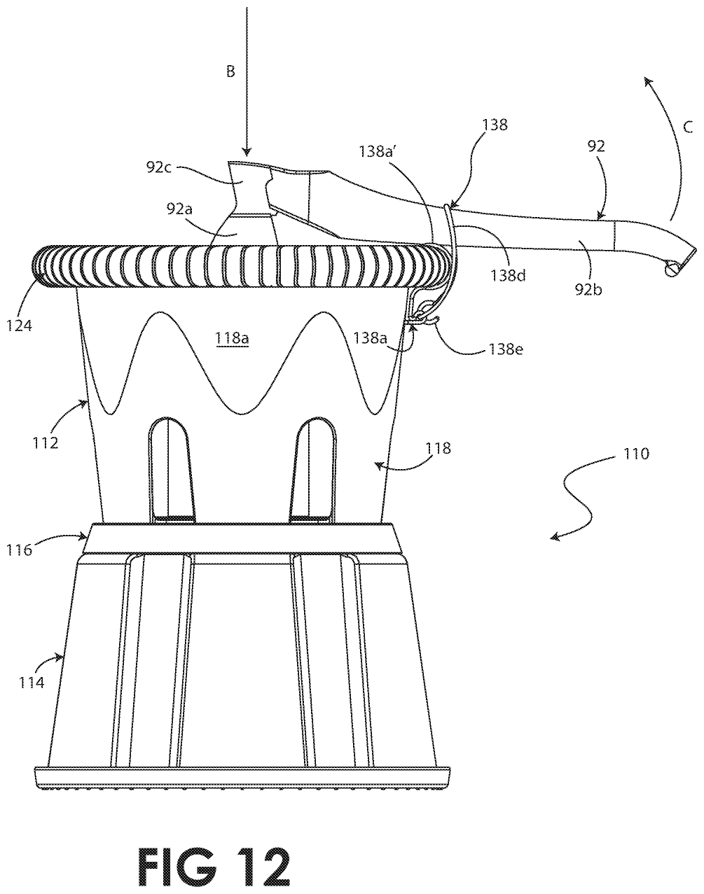

Referring now to FIGS. 11-13, there is shown a second embodiment of the wood splitting aid in accordance with the present disclosure, generally indicated at 110. Aid 110 is substantially identical to aid 10 with the exception of features that will be described hereafter. Aid 110 includes an upper receptacle 112, a lower receptacle 114, a connector assembly 116, and a resilient member 124. Upper receptacle 112 is identical to upper receptacle 12. Lower receptacle 114 is identical to lower receptacle 14. Connector assembly 116 is identical to connector assembly 16. Resilient member 124 is identical to resilient member 24. These components parts will therefore not be described in any additional detail.

Aid 110 differs from aid 10 in that it additionally includes a restraint 138. The restraint 138 is a device that may be utilized to hold ax 92 in engagement with aid 110 as will be described hereafter. Restraint 138 includes a pair of circumferentially spaced-apart fasteners 138a, 138b that are secured to upper section 118a of side wall 118 of upper receptacle 112. In particular, the restraint 138 may be snap-fittingly engaged over a portion of resilient member 124. A portion of at least one fastener 138a, 138b, such as portion 138a′, wraps over an exterior surface of resilient member 124 to more firmly anchor restraint 138 to aid 110. Although not shown in the attached figures, it will be understood that a similar portion may extend from fastener 138b and wrap over the exterior surface of resilient member 124. A link 138c extends along a portion of the exterior surface of upper section 118a between fastener 138a and fastener 138b. A similar link (not shown) may extend along an interior surface of upper section 118a. In this configuration, the restraint 138 may be moved circumferentially along resilient member 124 to any desired position. In other embodiments, a section of each fastener 138a, 138b extends through an aperture defined in side wall 118 to lock restraint 138 in a particular position on upper receptacle 112.

Restraint 138 also includes a detachable tether 138d that is secured to fasteners 138a, 138b. As illustrated, a first end of tether 138d is provided with a hook 138e that is detachably received through a hole defined by fastener 138a. The second end of tether 138d is also provided with a hook 138f that is detachably received through a hole defined by fastener 138b. (In other embodiments, instead of using a hook to engage the tether 138d to the fasteners, at least one of the first and second ends of the tether 138d may be fixedly secured to one of the fasteners 138a or 138b.)

Restraint 138 may be utilized in the following way. If a user of aid 110 attempts to chop a piece of firewood 90 with an ax 92, the blade 92a of ax 92 may be driven partially into the end 90a of the piece of firewood 90 but may not split the same, perhaps because the wood is some type of hard wood. The user may therefore decide to strike the head 92c of the ax 92 with something heavy in order drive blade 92a deeper into the wood. Alternatively, the user may be in a location where it is not necessary safe to wield the ax 92 in order to split the firewood 90. In this instance, the user may position the blade 92a in contact with the end 90a of firewood 90 and will strike the head 92c of ax 92 with a heavy object to drive the blade 92a into the wood. In either instance, the user may wish to strike a blow onto head 92c of ax 92 in the direction indicated by arrow “B”. The user, however, does not want the ax to accidentally be dislodged when this blow in the direction of arrow “B” is struck onto the head 92c of the ax or wants to hold the ax in a particular orientation so that blade 92a may be able to be driven into the wood.

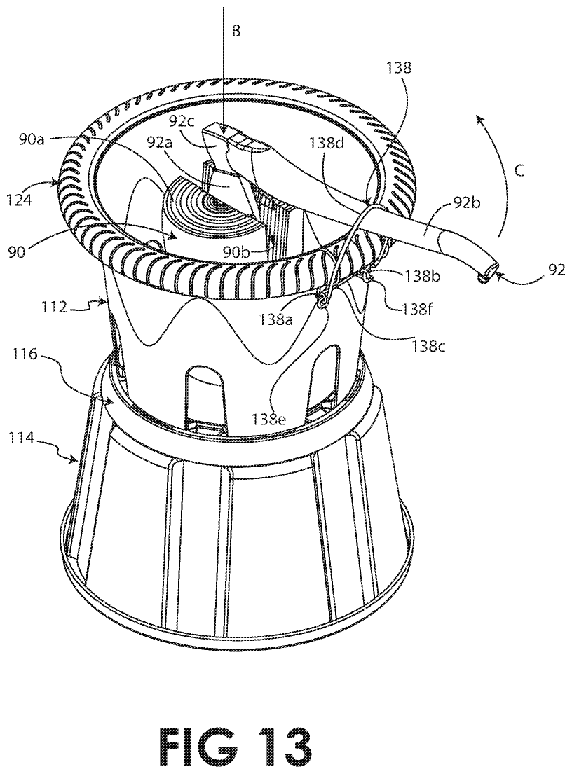

The user will therefore hold ax 92 in place with restraint 138 in the following way. The user will move restraint 138 along the resilient member 124 to align with the handle 92c of the ax 92 if the restraint 138 is not fixed in place thereon, or the user will rotate the wood 90 and ax 92 to align with the restraint 138 if the restraint is in a fixed position on the resilient member 124. Of course, the firewood 90 and ax 92 may be rotated to bring the handle 92b of the ax 92 into alignment with the restraint 138 even if the restraint 138 is able to move along resilient member 124. Resilient member 124 is utilized as a rest for handle 92b of ax 92. Once the handle 92b of ax 92 is located between fastener 138a and fastener 138b, one of the hooks 138e, 138f is disengaged from the associated fastener 138a, 138b and the tether 138d is passed over the top of the handle 92b. The disengaged hook 138e or 138f is then inserted again into its associated fastener 138a, 138b. Tether 138d effectively will prevent ax handle 92b and therefore ax 92, from flying upwardly or outwardly when ax head 92c is struck by a heavy object from above in the direction of arrow “B”. FIG. 11 shows blade 92a positioned to be forced into end 90a of firewood 90 when struck from above by an object moving the direction of arrow “B”. If wood 90 develops a crack 90b, such as is shown in FIG. 13, the user may lift handle 92a upwardly in the direction of arrow “C” to drive blade 92a deeper into wood 90 and enlarge the crack 90b. The user may repeatedly strike blows on ax head 92c in the direction of arrow “B” and lift handle 92b in the direction of arrow “C” until the wood is split in half. Once the firewood 92 is split, the user simply disengages one of the hoods 138e, 138f so that tether 138d is not secured at both ends to aid 110. Ax 92 may is then removable from its temporary engagement with aid 110.

It will of course be understood that aid 110 may be utilized to split firewood 90 in the identical manner described with respect to aid 10 and without using restraint 138.

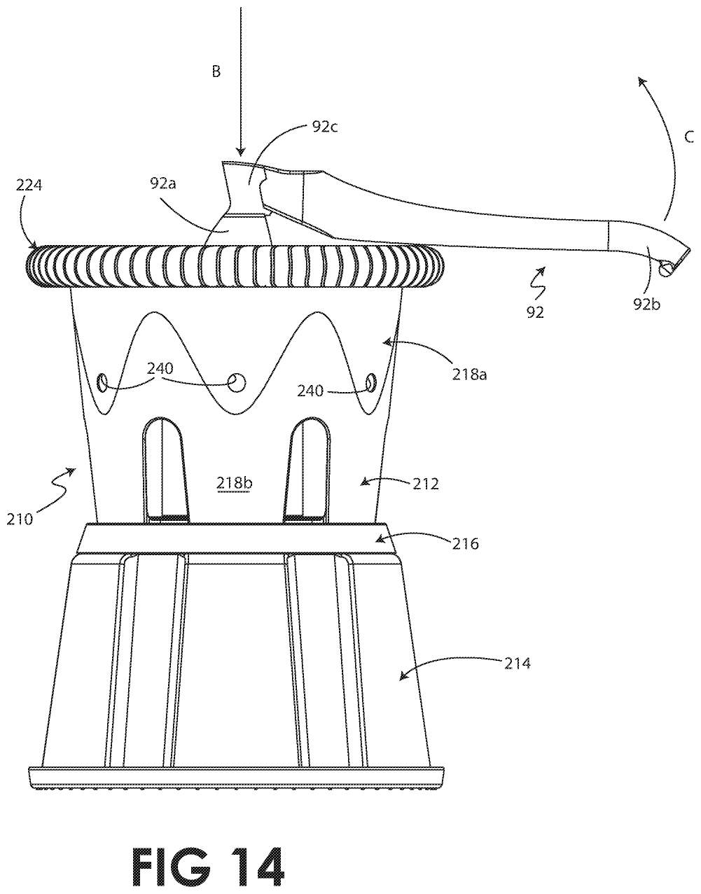

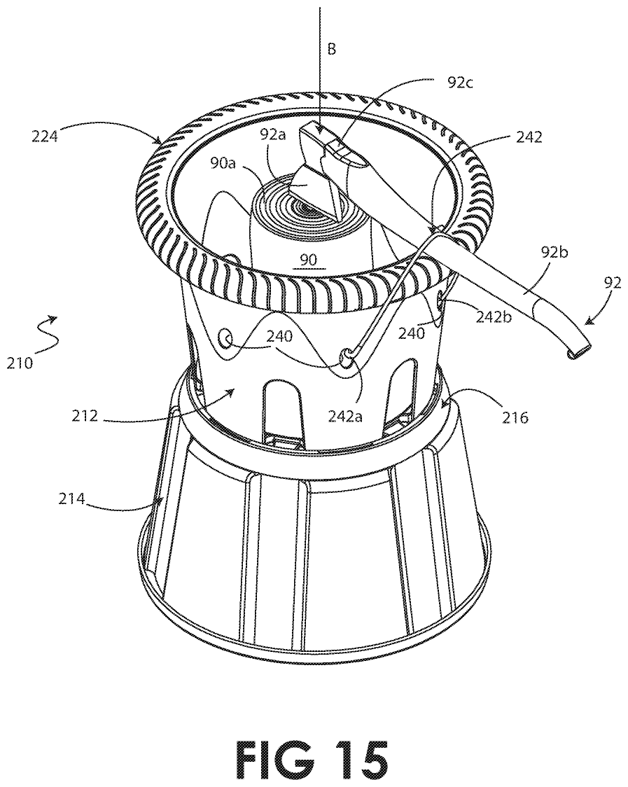

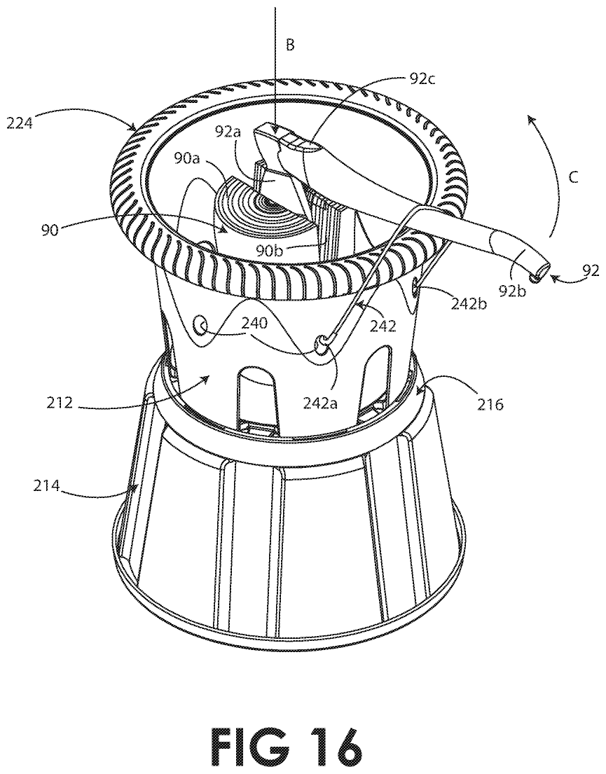

Referring to FIGS. 14-16, there is shown a third embodiment of a wood splitting aid in accordance with the present disclosure, generally indicated at 210. Aid 210 is substantially identical to aid 10 in every respect except for the features identified hereafter.

Aid 210 includes an upper receptacle 212, a lower receptacle 214, a connector assembly 216, and a resilient member 224. Upper receptacle 212 is substantially identical to upper receptacle 12. Lower receptacle 214 is identical to lower receptacle 14. Connector assembly 216 is identical to connector assembly 16. Resilient member 224 is identical to resilient member 24. These components parts will therefore not be described in any additional detail.

Aid 210 differs from aid 10 in that a plurality of through-holes 240 are defined in side wall 218. In particular, holes 240 are defined in resilient upper section 218a. It will be understood, however, that in other embodiments, the holes 240 may be defined in the rigid lower section 218b. Holes 240 extend from an interior surface of side wall 218 through to an exterior surface thereof.

Aid 210 as illustrated in FIGS. 14-16 may be utilized in exactly the same manner as aid 10 to split firewood. However, in similar circumstances to those described with respect to aid 110, it may at times be desirable to temporarily secure ax 92 to aid 210 in order to allow the user to strike the ax head 92c with a heavy object in the direction of arrow “B” or raise the ax handle 92b in the direction of arrow “C” in relative safety. In order to secure ax handle 92b in place, a tether 242 may be utilized. Tether 238 may be a length of elastic cord that has hooks 242a, 242b at either end. Tether 242 may be a bungee cord, for example.

The user will utilize tether 242 by engaging a first one of the hooks 242a, 242b in one of the holes 240 defined in side wall 218, pass the elastic cord over the top of the ax handle 92b and then insert the other of the hooks 242a, 242b into the adjacent hole 240 defined in side wall 218. The user may then strike ax head 92c with a heavy object to move ax blade 92a downwardly into the end 90a of firewood 90 to create a crack 90b therein.

It will be understood that instead of securing the hooks 242a, 242b in holes 240, one or both hooks 242a and 242b may be hooked onto the edge of the sidewall 218 of upper receptacle 212 that defines apertures 218. A tether 242 may be utilized in this manner with any of the other aids 10, 110 etc. disclosed herein if the holes 240 are not provided in side wall 218.

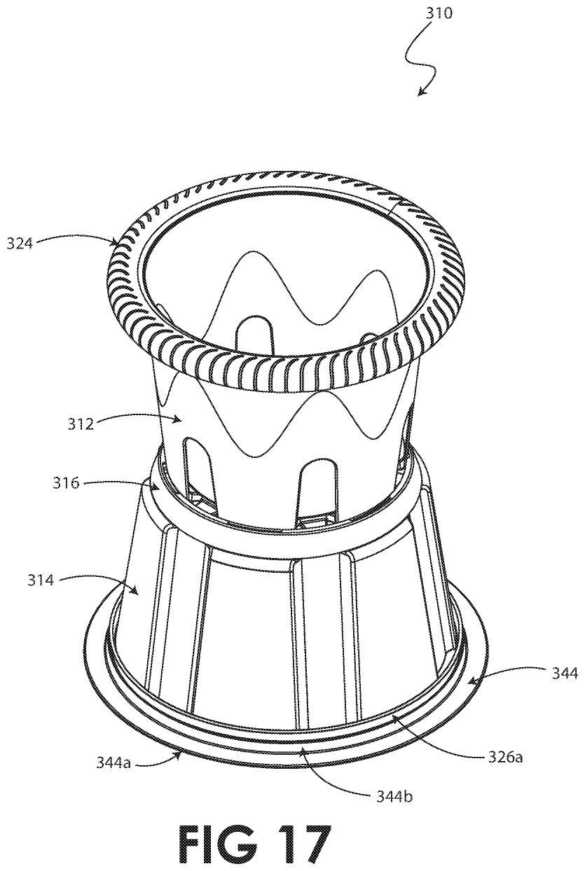

Referring now to FIGS. 17-19, there is shown a fourth embodiment of a wood splitting aid in accordance with an aspect of the present disclosure, generally indicated at 310.

Aid 310 is substantially identical to aid 10 with the exception of features that will be described hereafter. Aid 310 includes an upper receptacle 312, a lower receptacle 314, a connector assembly 316, and a resilient member 324. Upper receptacle 312 is identical to upper receptacle 12. Lower receptacle 314 is identical to lower receptacle 14. Connector assembly 316 is identical to connector assembly 16. Resilient member 324 is identical to resilient member 24. These components parts will therefore not be described in any additional detail.

Aid 310 differs from aid 10 in that it also includes a base 344 that is selectively engaged with lower receptacle 314. Base 344 is particularly suited to helping support the aid 310 on softer ground “SG”. If any of the aids 10, 110, 210 are placed on soft ground “SG” and firewood is placed therein and is struck from above in order to split the firewood, there may be a tendency for part of the aid to sink into the soft ground. This in turn, will tend to cause the plate (such as plate 32) to be oriented at an angle instead of being horizontally oriented. As a consequence, the firewood held within the interior cavity of the upper receptacle 12, 112, 212 may tend to fall against a lowermost part of the interior surface of the upper receptacle and tip the entire aid over. The aid may only tip over when the ax blade strikes the firewood and this can present a safety hazard to the user who may now contact an unintended part of the aid or the firewood with the ax blade.

In order to reduce the tendency for the aid 310 to sink into softer ground “SG”, aid 310 is provided with a base 344 that is of a greater diameter than the widest part of lower receptacle 314. The greater diameter base 344 causes the weight of aid 310 plus any firewood retained therein to be distributed over a larger region of the softer ground “SG”. As a consequence, there will be less of a tendency for aid 310 to sink into the softer ground “SG”.

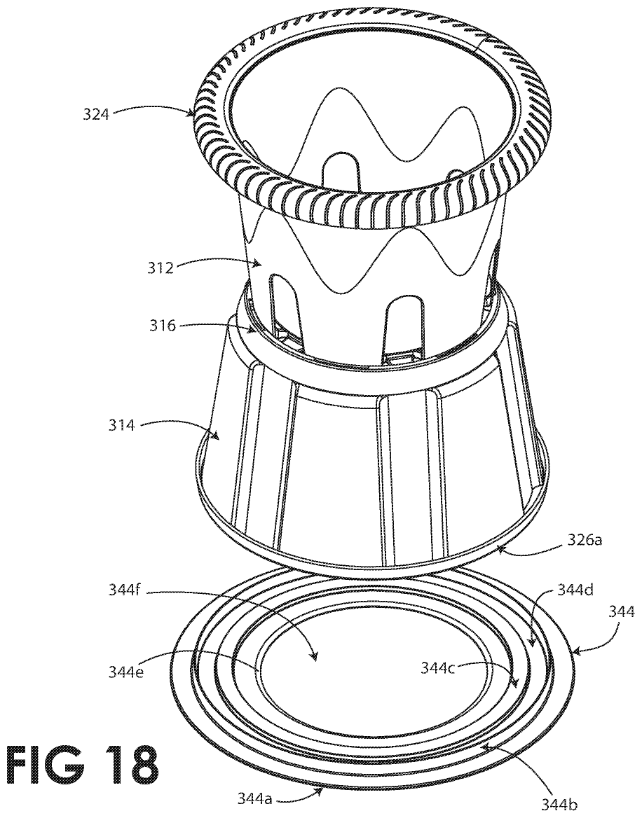

Referring to FIG. 18, base 344 includes a bottom wall 344a that has a lowermost surface adapted to contact the softer ground “SG”. Bottom wall 344a includes a plurality of gripping ribs 344a′ thereon that help bottom wall 344a find purchase in the softer ground “SG”. The ribs 344a′ dig into the softer ground “SG” and resist the tendency of the base 344a to move laterally across the ground during use of aid 310.

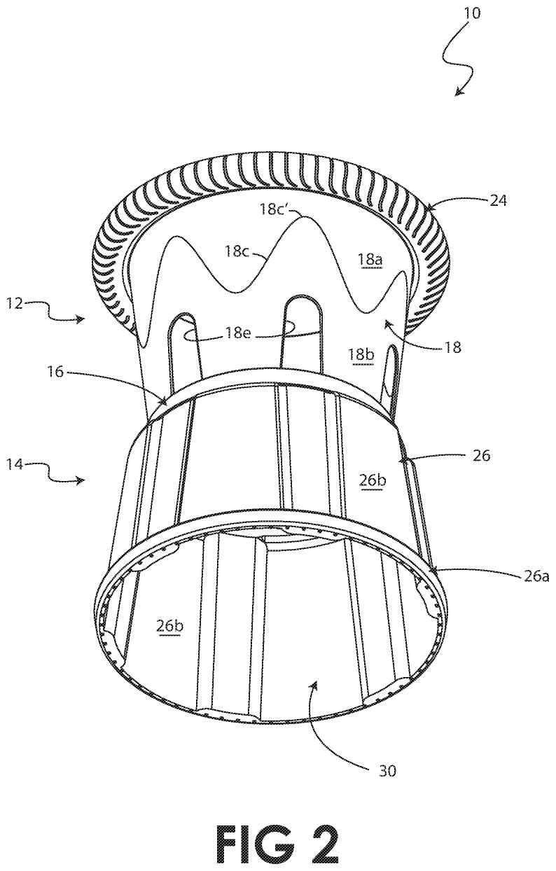

Base 344 includes an outer wall 344b and an inner wall 344c that define between them an annular channel 344d. Annular channel 344d is complementary in shape and size to rim 326a of lower receptacle 314. When base 344 is engaged with lower receptacle 314, the lower end of lower receptacle 314 which includes rim 326a is received within channel 344d. Base 344 is held onto lower receptacle 314 through a friction-fit thereof within channel 344d of base 344. Base 344 has an interior surface 344e which bounds and defines an opening 344f that is placed in fluid communication with the chamber defined by lower receptacle 314 (i.e., with the chamber of 310 that is substantially identical to chamber 30 shown in FIG. 2). As best seen in FIG. 17, a portion of the bottom wall extends circumscribes the outer wall 344b and extends outwardly for a distance beyond outer wall 344b. The width of the portion of the bottom wall 344a which extends beyond outer wall 344b may be of any desired size that is suitable for different types of soft ground. The user may select the particular diameter of base 344 most suitable for the soft ground conditions in which they may wish to use the aid 310.

In order to use aid 310, base 344 is snap-fittingly engaged with lowermost end and rim 326a of lower receptacle 314. Base 344 is then rested on the softer ground “SG” in such a way that ribs 344a′ dig into the ground. Aid 310 is rotated and moved around to seat the same as stably as possible (and as level as possible) on the softer ground “SG”. Aid 310 may then be used in the same manner as aid 10 to split firewood.

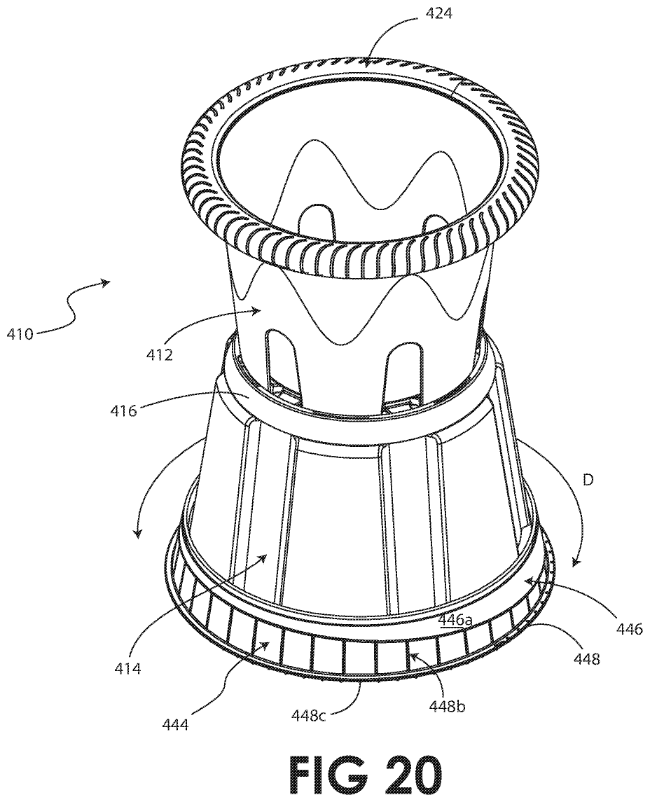

Referring now to FIGS. 20-24, there is shown a fifth embodiment of a wood splitting aid in accordance with an aspect of the present disclosure, generally indicated at 410. Aid 410 is substantially identical to aid 10 with the exception of features that will be described hereafter. Aid 410 includes an upper receptacle 412, a lower receptacle 414, a connector assembly 416, and a resilient member 424. Upper receptacle 412 is identical to upper receptacle 12. Lower receptacle 414 is identical to lower receptacle 14. Connector assembly 416 is identical to connector assembly 16. Resilient member 424 is identical to resilient member 24. These components parts will therefore not be described in any additional detail.

Aid 410 differs from aid 10 in that it further includes a leveling base 444. Leveling base 444 comprises a first base section 446 and a second base section 448. First base section 446 is configured for engagement with lower receptacle 414 of aid 410 and second base section 448 is configured for engagement with first base section 448.

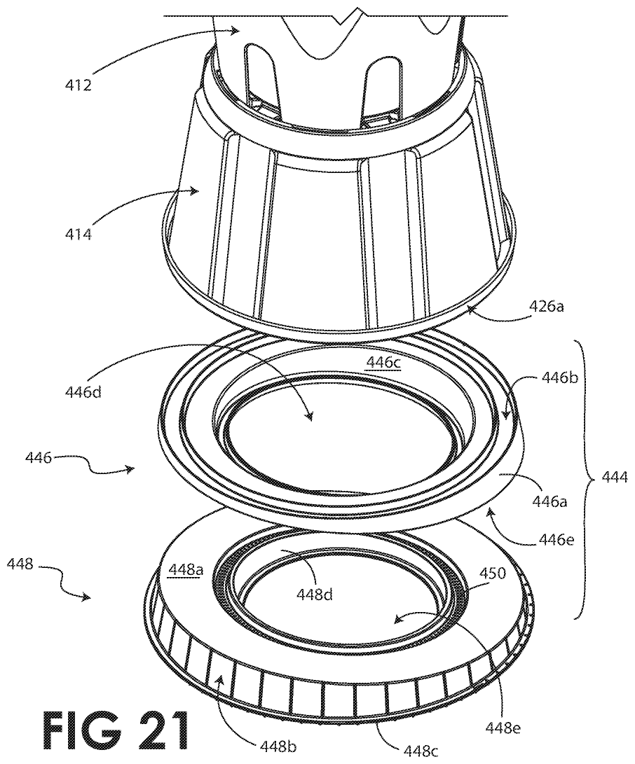

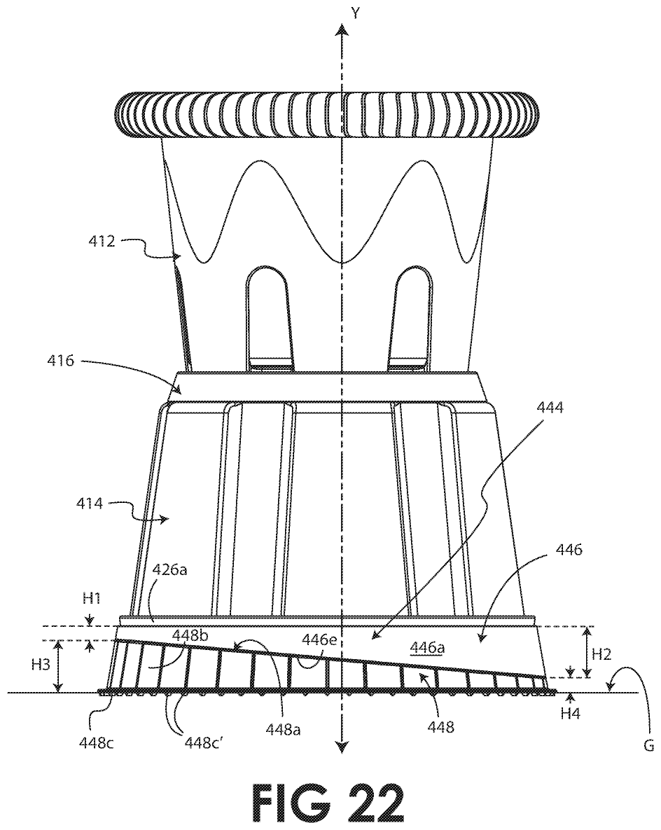

As best seen in FIGS. 21 and 22, first base section 446 includes a circumferential wall 446a that is of a first height “H1” on a first side of the aid 410 and is of a second height “H2” on a second side of the aid 410. The outermost wall 446a tapers in height between the first side and the second side. First base section 446 also includes an annular groove 446b (FIG. 18) which is configured to receive rim 426a of lower receptacle 414 therein. Rim 426a may be frictionally be retained within groove 446b, thereby securing first base section 446 to lower receptacle 414. First base section 446 includes an annular interior surface 446c that bounds and defines an opening 446d.

Referring to FIG. 21, second base section 448 includes an upper wall 448a upon which a bottom wall 446e of first base section 446e is seated. Second base section 448 further includes a circumferential wall 448b that extends downwardly from upper wall 448a. A bottom wall 448c of second base section 448 is also provided. Bottom wall 448 may be provided with a plurality of ribs 448c′ that extend downwardly therefrom to act as gripping surfaces. Second base section 448 includes an interior wall 448d that bounds and defines an opening 448e that is alignable with opening 446d of first base section 446.

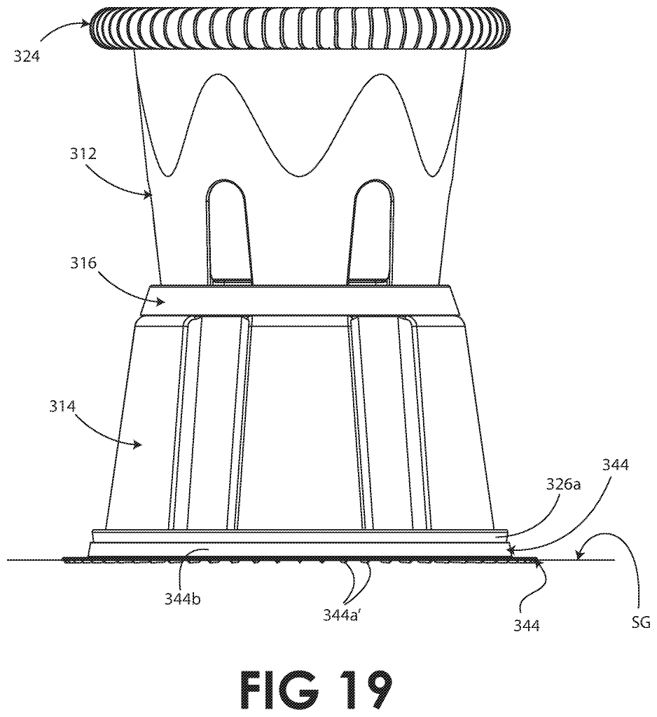

Wall 448b, like first base section 446a is of a third height “H3” (FIG. 19) on the first side of the aid 410 and is of a fourth height “H4” on the second side of aid 410. Height “H3” may be of the same height as height “H2” and height “H4” may be of the same height as height “H1”. If this is the case, then when first and second base sections 446, 448 are arranged as in FIG. 22, aid 410 is able to be stood on level ground “G” such that the uppermost end 410a of aid 410 is substantially parallel to ground “G” and the longitudinal axis “Y” is normal to the ground “G”, i.e., at 90 degrees relative thereto.

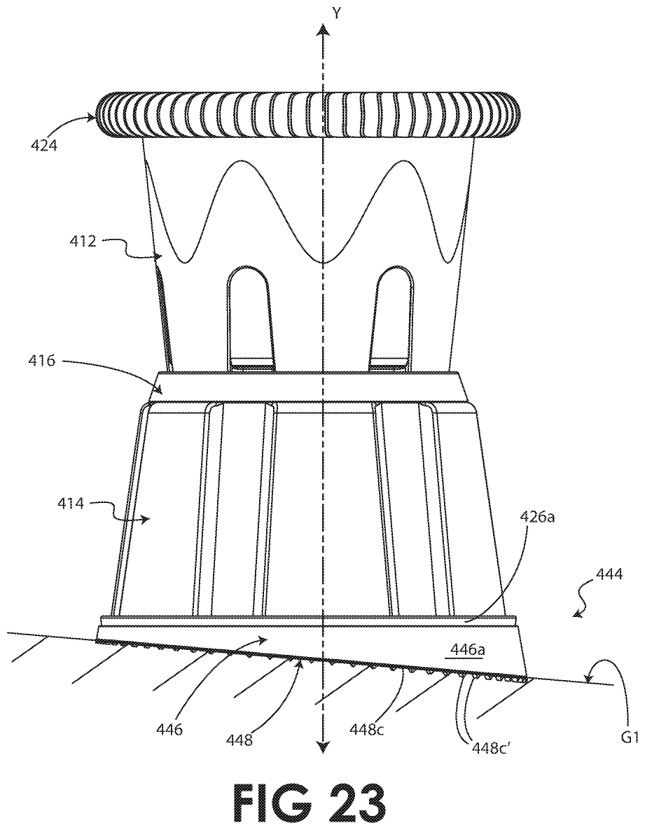

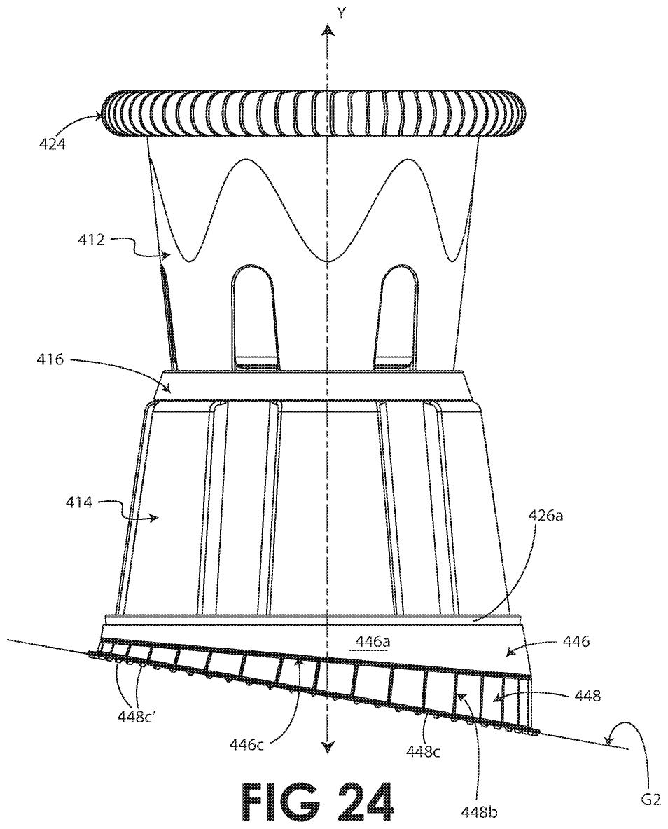

Leveling base 444 is, however, provided to help aid 410 be held is such a way that longitudinal axis “Y” remains vertically oriented regardless of whether the ground upon which aid 410 is resting is horizontal, such as ground “G” in FIG. 21, or is inclined at a relatively gentle angle such as ground “G1” in FIG. 23, or an even steeper angle, such as ground “G2” in FIG. 24. In order to make this possible, first and second base sections 446, 448 are provided with an adjustment assembly that enables them to be adjusted relative to each other. This adjustment assembly make take any of a number of different forms. However, the adjustment assembly illustrated in FIG. 21 enables the user to adjust the adjustment assembly without the use of any tools. The adjustment assembly may be adjusted simply by rotating second base section 448 relative to first base section 446 or by rotating first base section 446 and lower receptacle 414 relative to second base section 448. Adjustment assembly may, for example, comprise a rack and pinion type gear mechanism. FIG. 21 shows a rack 450 of a rack and pinion type gear mechanism provided in a groove defined in upper wall 448a of second base section 448. It will be understood that the pinion, though not shown in this figure, will be provided in a complementary region defined on the bottom wall 446e of first base section 446. Obviously, the rack may, instead, be provided on first base section 446 and the pinion may be provided on second base section 448. In other instances, first and second base section 446 may be threaded engaged with each other by mating threaded regions that enable the first and second base sections 446, 448 to be rotated relative to each other.

First and second base sections 446, 448 may be rotated to a first position shown in FIG. 22 where the combined minimum height “H1” of first base section 446 and maximum height “H3” of second base section 448 is equal to the maximum height “H2” of first base section 446 plus the minimum height “H4” of second base section 448. As indicated earlier herein, first and second base sections 446, 448 will be arranged in this configuration to safely support aid upper receptacle 412 on level ground “G”.

FIG. 20 shows that the ground “G1” inclined at a first angle and the leveling base 444 adjusted to accommodate this first angle. In this particular instance, the second base section 448 has been rotated in either direction indicated by arrow “D” (FIG. 17) in order to bring the minimum height region “H4” thereof into alignment with the minimum height region “H1” of first base section 446. When this occurs, the second base section 448 is received fully within a channel (not shown) defined in bottom wall 446d of first base section 446. The bottom wall 448c of second base section 448 is slightly visible below bottom wall 446d of first base section 446. The leveler base 444 is of a height “H1” on the first side of the aid 410 and is of a height “H3” on the other side of the aid 410.

FIG. 21 shows the ground “G2” inclined at a second angle that is steeper than the angle “G2” and further shows the second base section 448 adjusted to accommodate this second angle. In this particular instance, the second base section 448 has been rotated in either direction indicated by arrow “D” (FIG. 17) in order to bring the maximum height region “H3” thereof into alignment with the maximum height region “H2” of first base section 446. When this occurs, the entire second base section 448 is located out of the channel defined in the first base section 446 and the entire second base section 448 is visible below bottom wall 446d of first base section 446. The leveler base 444 is of a height “H1+H4” on the first side of the aid 410 and is of a height “H2+H3” on the other side of the aid 410.

In all of the instances shown in FIGS. 22, 23 and 24, the upper receptacle 412 is held in the correct orientation for a user to split firewood therein. It will be understood that leveler base 444 may be adjusted to a number of different positions intermediate the two extremes shown in FIG. 23 and FIG. 24. Once the aid 410 is correctly leveled relative to the ground upon which it rests, the user may use aid 410 in substantially the same manner as aid 10.

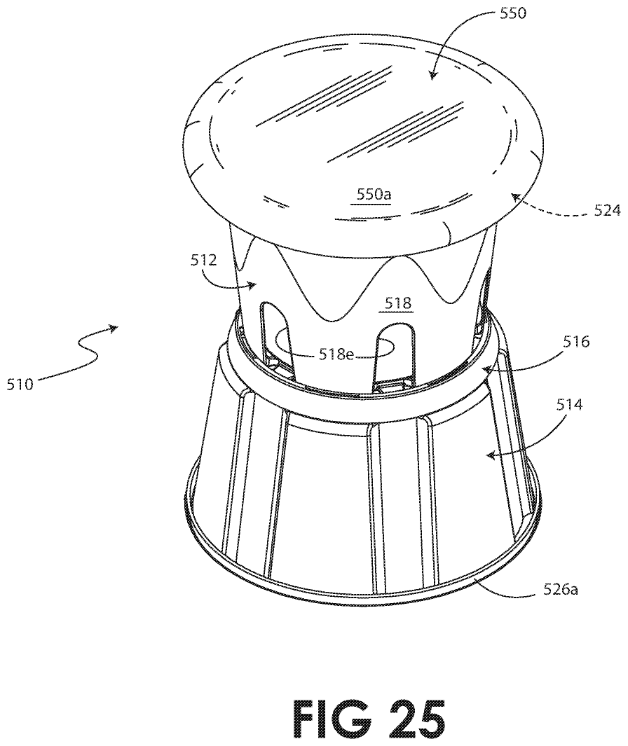

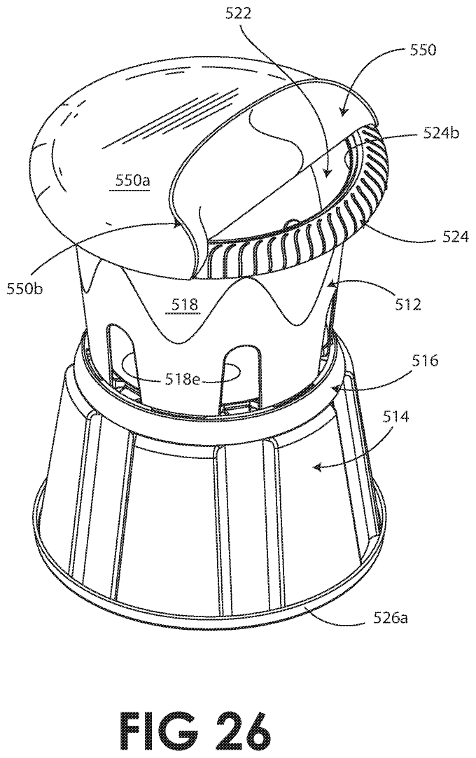

Referring to FIGS. 25 and 26, there is shown a sixth embodiment of a wood splitting aid in accordance with an aspect of the present disclosure, generally indicated at 510. Aid 510 is substantially identical to aid 10 with the exception of features that will be described hereafter. Aid 510 includes an upper receptacle 512, a lower receptacle 514, a connector assembly 516, and a resilient member 924. Upper receptacle 512 is identical to upper receptacle 12. Lower receptacle 514 is identical to lower receptacle 14. Connector assembly 516 is identical to connector assembly 16. Resilient member 924 is identical to resilient member 24. These components parts will therefore not be described in any additional detail.

Aid 510 differs from aid 10 in that it further includes a rain bib 550. Rain bib 550 is comprised of a flexible waterproof fabric 550a and includes an elasticized edging 550b (FIG. 26). Rain bib 550 is pulled over the resilient member 924 to close off access to the opening 924b defined therein and thereby to interior cavity 922 defined by upper receptacle 512. The rain bib 550 is shaped and sized such that the elasticized edging 550b tends to be seated adjacent the exterior surface of side wall 518 when rain bib 550 is engaged with upper receptacle 512. When a user wishes to store aid 510 and prevent rain and snow from entering into interior cavity 922, rain bib 550 is engaged with upper receptacle 512 as shown in FIG. 25. Firewood may be kept within interior cavity 922 and will be at least somewhat kept dry by covering aid with rain bib 550. Rain bib 550 is pulled off the upper receptacle 512 when it is desired to use aid 510.

It will be understood that rain bib 550 is exemplary of any type of covering that may be engaged with any of the wood splitting aids disclosed herein. Instead of terminating below the lowermost surface of resilient member 924 as does rain bib 550, other differently sized rain bibs may terminate proximate connector assembly 516. In this instance, access to interior cavity through opening 924b and through apertures 518e will be prevented. In yet other embodiments, rain bib 550 may extend down to bottom rim 926a of lower receptacle 514 to protect the entire aid 510.

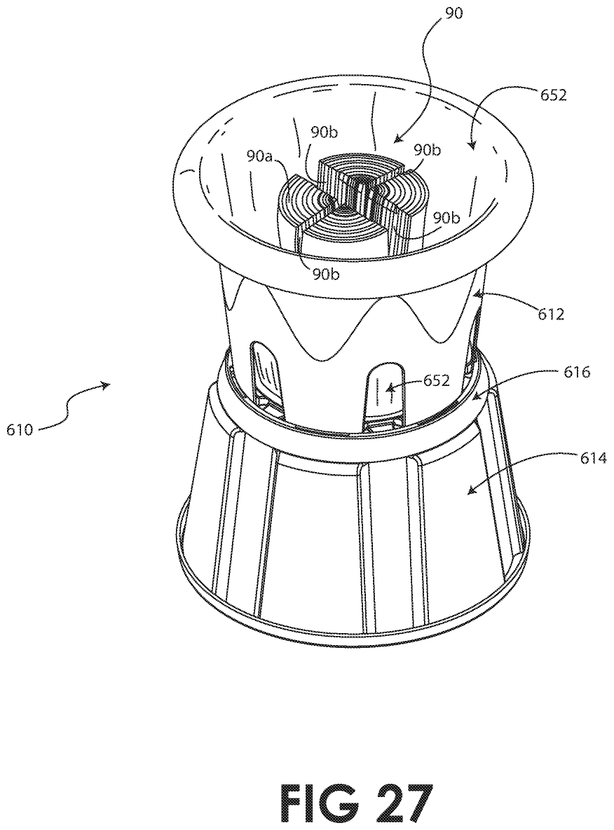

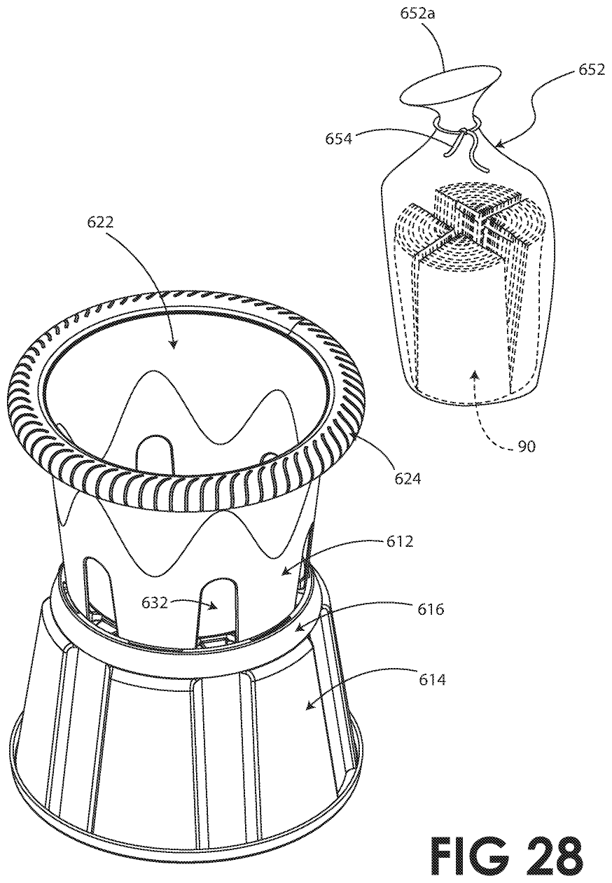

Referring to FIGS. 27 and 28, there is shown a seventh embodiment of a wood splitting aid in accordance with an aspect of the present disclosure, generally indicated at 610. Aid 610 is substantially identical to aid 10 with the exception of features that will be described hereafter. Aid 610 includes an upper receptacle 612, a lower receptacle 614, a connector assembly 616, and a resilient member 624. Upper receptacle 612 is identical to upper receptacle 12. Lower receptacle 614 is identical to lower receptacle 14. Connector assembly 616 is identical to connector assembly 16. Resilient member 624 is identical to resilient member 24. These components parts will therefore not be described in any additional detail.

Aid 610 differs from aid 10 in that it further includes a liner 652. Liner 652 is complementary shaped and sized to line interior cavity 622 of upper receptacle 612. Liner 652 will be placed within interior cavity 622 such that at least a portion thereof extends outwardly over resilient member 624. Wood is then placed on top of the bottom region of the liner 652 such that the wood effectively rests upon the plate at the bottom of upper receptacle (i.e., the plate similar to plate 32 described earlier herein). The wood is then split as described herein with respect to any of the aids 10, 110, 210, 310, 410 and 510. When the splitting operation is finished, the user is able close the liner 652 in any suitable manner, if desired. As illustrated in FIG. 28, a piece of string 654 may be used to close liner 652. The user is able to lift the split wood out of the upper receptacle 612 within the liner 652 and carry the same to a new location. The liner 652 keeps any split off wood bark and smaller shards from making a mess in the area surrounding aid 610. It will be understood that a closure such as string 654 is not required. If no closure is utilized, the user may simply pull the outermost edge 652a toward a central location and then grasp the top end of the liner 652 out of upper receptacle 612 while holding the top end of the liner 652 in their hand.

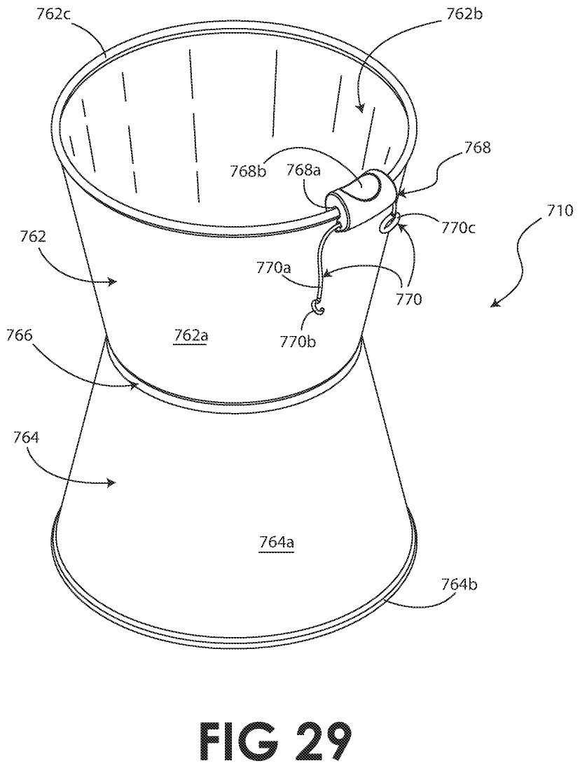

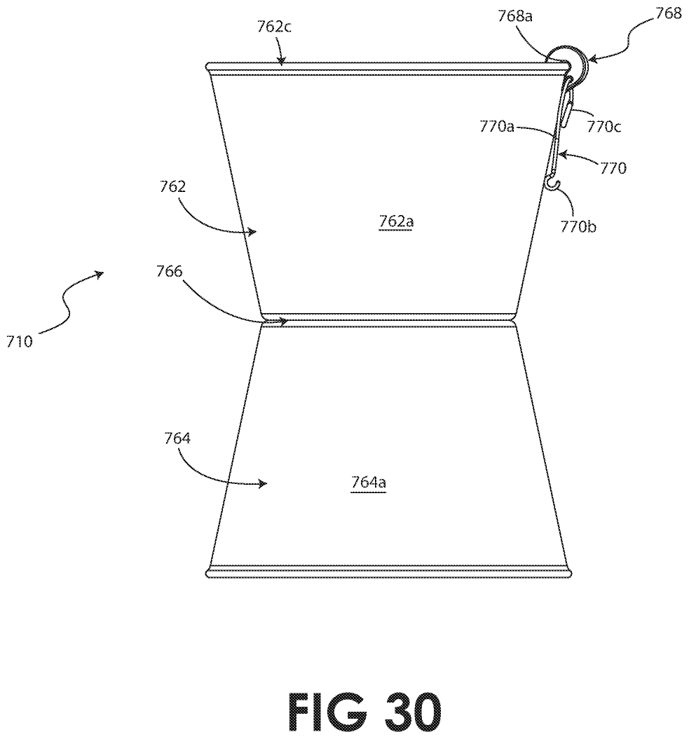

Referring to FIGS. 29-32 there is shown an eighth embodiment of a wood splitting aid in accordance with an aspect of the present disclosure, generally indicated at 710. Aid 710 is substantially similar to the wood splitting aid disclosed in U.S. patent application Ser. No. 15/361,662 filed Nov. 28, 2016, to the same inventor and applicant, which application is incorporated herein by reference. Aid 710 differs from the wood splitting aid disclosed in the aforementioned patent application in a number of ways, as will be expanded upon below.

Aid 710 includes an upper receptacle 762, a lower receptacle 764, and a connector assembly 766. There is no resilient member similar to resilient member 24 provided on aid 710. Connector assembly 766 is a threaded connection where one of the upper receptacle 762 and lower receptacle 764 includes an exteriorly threaded region and the other of the upper receptacle 762 and lower receptacle 764 includes a mating interiorly threaded region. The exteriorly threaded region and interiorly threaded region are threadedly engaged with each other to secure the upper receptacle 762 and lower receptacle 764 together so that they form a single unit.

Upper receptacle 762 has a bottom wall (not shown) and a side wall 762a that bound and define an interior cavity 762b within which a piece of wood is received in the same manner as described herein within respect to any of the other aids. Upper receptacle 762 includes an upper rim 762c that bounds and defines an opening to interior cavity 762b.

Lower receptacle 764 includes a top wall (not shown) that abuts bottom wall of upper receptacle 762 when upper and lower receptacles 762, 764 are engaged with each other. Lower receptacle 764 further includes a side wall 764a that extends downwardly to a rim 764b. Rim 764b will rest upon the ground surface when aid 710 is to be used in a firewood splitting operation. Although not shown herein, lower receptacle defines an interior chamber similar to interior cavity 762b and rim 764b defines an opening through which interior chamber may be accessed.

In accordance with an aspect of the present disclosure, aid 710 includes a handle rest 768 that is capable of being interlockingly engaged with rim 762c of upper receptacle 762. Handle rest 768 comprise a cylindrical member fabricated from a resilient material such as rubber. A longitudinal slot 768a is defined in the cylindrical member. Slot 768a extends from a first end of the cylindrical member to a second end thereof. Slot 768 is slightly smaller in width than the width of rim 762c so that when handle rest 768 is engaged with rim 762c, handle rest 768 is retained on rim 762c by friction. Handle rest 768 may be engaged in any desired position on rim 762c.

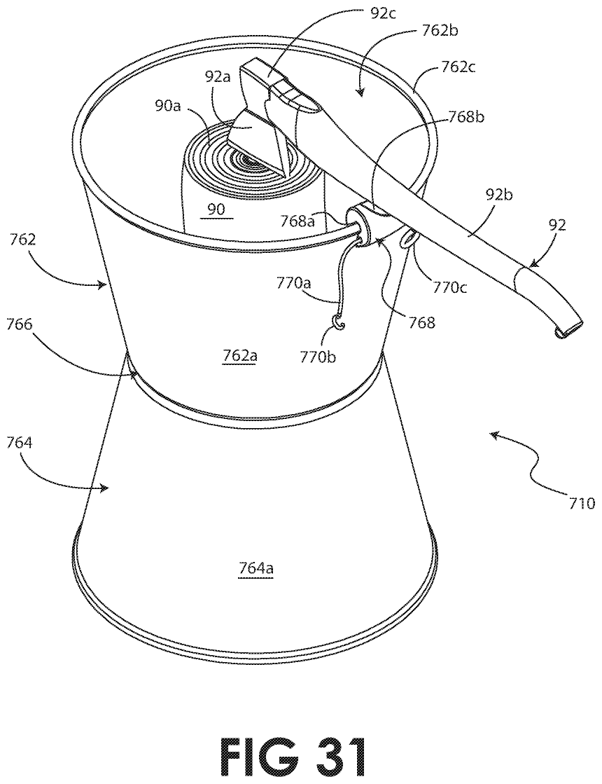

Handle rest 768 includes a seat 768b that is slightly concave so that it cradles a section of an ax handle therein as shown in FIG. 31. Handle rest further includes a restraint 770. Restraint is comprised of a tether 770a that is threaded through a longitudinal aperture defined in the cylindrical member. A hook 770b is secured at a first end of the tether 770a. A ring 770c is provided at a second end of the tether 770a.

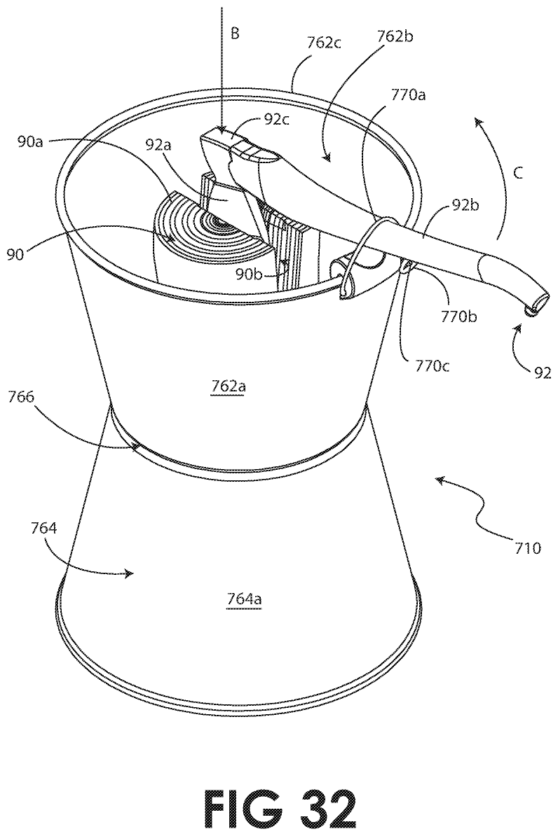

Aid 710 is used by placing a piece of firewood 90 on the bottom wall of upper receptacle 762. A blade 92a of an ax 92 is positioned against an end 90a of the piece of firewood 90 and the ax handle 92b is placed on seat 768b of rest 768. Tether 770a is placed over a top surface of ax handle 92b and hook 770b is engaged in ring 770c. The user may then strike the ax head 92b with a heavy object in order to drive the blade 92a downwardly in the direction of arrow “B” (FIG. 32) and split the firewood 90. Handle 92b may also be lifted upwardly in the direction of arrow “C” to aid in the splitting of the firewood 90 as has been previously described herein. When the splitting operation is completed, hook 770b may be removed from ring 770c and tether 770a may be withdrawn from over ax handle 92b.

In another aspect, an exemplary embodiment of the present disclosure may provide a method of splitting wood 90 comprising placing a lower receptacle 14 of a wood splitting aid 10 on a flat surface “G”; placing an upper receptacle 12 of the wood splitting aid 10 onto a top end of the lower receptacle 14; engaging a connector assembly 16 of the wood splitting aid 10 to secure the upper receptacle 12 and lower receptacle 14 together; providing a resilient member 24 or 768 of the wood splitting aid 10 or 710 on an upper end of the upper receptacle 12; placing a piece of wood 90 into a cavity 22 or 722 bounded and defined by a side wall of the upper receptacle 12, 712; striking the piece of wood 90 with a blade 92a of a chopping tool 92; splitting the piece of wood 90 into smaller pieces of wood (such the pieces shown in FIG. 27); and absorbing some of a force generated by striking the piece of wood 90 with the chopping tool 92 with the resilient member 24 or 768.

In one embodiment, the method may provide transferring some of the force generated by striking the piece of wood 90 from the resilient member 24 to a flexible portion 18a of the side wall 18 of the upper receptacle 12. In one embodiment, the method may provide transferring some of the force from the side wall 18 of the upper receptacle 12 to a rigid sidewall 26 of the lower receptacle 14. In one embodiment, the method may provide transferring some of the force from the rigid sidewall 26 of the lower receptacle 14 to the flat surface “G”, “G1”, “G2”, or “SG”.

In one embodiment, the method may provide containing the smaller pieces of firewood in the cavity 22 of the upper receptacle 12. In one embodiment, the engaging of the connector assembly 16 includes aligning tabs 20c on a bottom wall 20 of the upper receptacle 12 with flanges 34e on a collar 34 that extends around an exterior surface of a bottom end of the upper receptacle 12 and a top end of the lower receptacle 14. In one embodiment, the aligning includes rotating the collar 34 about the exterior surface of the bottom end of the upper receptacle 12 and the top end of the lower receptacle 14. In one embodiment, the method may provide removing bark and shards of wood generated by splitting the wood from the cavity through at least one aperture 18e defined in a side wall 18 of the upper receptacle.

In one embodiment, the method may provide placing a section of a handle 92b of the chopping tool 92 on the resilient member 24, 124, 224, 324, 424, 525, 624,or 768; wrapping a tether 138, 242, or 770 over a top of the handle 92b; and securing the tether 138, 242, or 770 to one of the side wall of the upper receptacle 12 or to the resilient member 24, 124, 224, 324, 424, 525, 624,or 768. In one embodiment, the method may provide positioning a blade 92a of the chopping tool 92 on the piece of wood 90; striking a head 92c of the chopping tool 92 with a heavy object; and driving the blade 92a into the piece of wood 90.

In one embodiment, the method may provide engaging a base 344 with a lower end 326a of the lower receptacle 314, wherein the base 344 is of a greater diameter than the lower end 326a of the lower receptacle 314; and placing a bottom surface 344a of the base 344 on the flat surface; wherein the base 344 is engaged with the lower receptacle 314 when the flat surface is a soft surface “SG”.

In one embodiment, the method may provide engaging a first base 446 section of an adjustable base 444 with a lower end 426a of the lower receptacle 414; rotating a second base section 448 of the adjustable base 444 relative to the first base section 446; changing an angle of a bottom surface 448c of the second base surface 448 relative to the lower end 426a of the lower receptacle 414; and placing the bottom surface 448c of the second base section 448 on an inclined flat surface such as “G1” or “G2”.

In one embodiment, the method may provide engaging a rain bib 550 over an upper end of the upper receptacle 12 for storage; and removing the rain bib 550 to use the wood splitting aid. In one embodiment, the method may provide placing a liner 652 around an interior surface of the wood splitting aid that defines the cavity 22 prior to placing the piece of wood 90 into the cavity 22. In one embodiment, the method may further provide removing the liner 652 with the smaller pieces of wood therein from the cavity of the upper receptacle.

It will be understood that in one embodiment, the upper receptacle may be utilized on its own as a wood splitting aid. In other words, the lower receptacle and the connector assembly may be omitted. The bottom wall of the upper receptacle may be placed directly on a flat surface, a piece of wood to be split may be positioned within the interior cavity of the upper receptacle and the user may then split the wood as described earlier herein.

Various inventive concepts may be embodied as one or more methods, of which an example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

While various inventive embodiments have been described and illustrated herein, those of ordinary skill in the art will readily envision a variety of other means and/or structures for performing the function and/or obtaining the results and/or one or more of the advantages described herein, and each of such variations and/or modifications is deemed to be within the scope of the inventive embodiments described herein. More generally, those skilled in the art will readily appreciate that all parameters, dimensions, materials, and configurations described herein are meant to be exemplary and that the actual parameters, dimensions, materials, and/or configurations will depend upon the specific application or applications for which the inventive teachings is/are used. Those skilled in the art will recognize, or be able to ascertain using no more than routine experimentation, many equivalents to the specific inventive embodiments described herein. It is, therefore, to be understood that the foregoing embodiments are presented by way of example only and that, within the scope of the appended claims and equivalents thereto, inventive embodiments may be practiced otherwise than as specifically described and claimed. Inventive embodiments of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the inventive scope of the present disclosure.

All definitions, as defined and used herein, should be understood to control over dictionary definitions, definitions in documents incorporated by reference, and/or ordinary meanings of the defined terms.

The articles “a” and “an,” as used herein in the specification and in the claims, unless clearly indicated to the contrary, should be understood to mean “at least one.” The phrase “and/or,” as used herein in the specification and in the claims (if at all), should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc. As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

When a feature or element is herein referred to as being “on” another feature or element, it can be directly on the other feature or element or intervening features and/or elements may also be present. In contrast, when a feature or element is referred to as being “directly on” another feature or element, there are no intervening features or elements present. It will also be understood that, when a feature or element is referred to as being “connected”, “attached” or “coupled” to another feature or element, it can be directly connected, attached or coupled to the other feature or element or intervening features or elements may be present. In contrast, when a feature or element is referred to as being “directly connected”, “directly attached” or “directly coupled” to another feature or element, there are no intervening features or elements present. Although described or shown with respect to one embodiment, the features and elements so described or shown can apply to other embodiments. It will also be appreciated by those of skill in the art that references to a structure or feature that is disposed “adjacent” another feature may have portions that overlap or underlie the adjacent feature.

Spatially relative terms, such as “under”, “below”, “lower”, “over”, “upper”, “above”, “behind”, “in front of”, and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if a device in the figures is inverted, elements described as “under” or “beneath” other elements or features would then be oriented “over” the other elements or features. Thus, the exemplary term “under” can encompass both an orientation of over and under. The device may be otherwise oriented (rotated 90 degrees or at other orientations) and the spatially relative descriptors used herein interpreted accordingly. Similarly, the terms “upwardly”, “downwardly”, “vertical”, “horizontal”, “lateral”, “transverse”, “longitudinal”, and the like are used herein for the purpose of explanation only unless specifically indicated otherwise.

Although the terms “first” and “second” may be used herein to describe various features/elements, these features/elements should not be limited by these terms, unless the context indicates otherwise. These terms may be used to distinguish one feature/element from another feature/element. Thus, a first feature/element discussed herein could be termed a second feature/element, and similarly, a second feature/element discussed herein could be termed a first feature/element without departing from the teachings of the present invention.

An embodiment is an implementation or example of the present disclosure. Reference in the specification to “an embodiment,” “one embodiment,” “some embodiments,” “one particular embodiment,” or “other embodiments,” or the like, means that a particular feature, structure, or characteristic described in connection with the embodiments is included in at least some embodiments, but not necessarily all embodiments, of the invention. The various appearances “an embodiment,” “one embodiment,” “some embodiments,” “one particular embodiment,” or “other embodiments,” or the like, are not necessarily all referring to the same embodiments.

If this specification states a component, feature, structure, or characteristic “may”, “might”, or “could” be included, that particular component, feature, structure, or characteristic is not required to be included. If the specification or claim refers to “a” or “an” element, that does not mean there is only one of the element. If the specification or claims refer to “an additional” element, that does not preclude there being more than one of the additional element.

As used herein in the specification and claims, including as used in the examples and unless otherwise expressly specified, all numbers may be read as if prefaced by the word “about” or “approximately,” even if the term does not expressly appear. The phrase “about” or “approximately” may be used when describing magnitude and/or position to indicate that the value and/or position described is within a reasonable expected range of values and/or positions. For example, a numeric value may have a value that is +/−0.1% of the stated value (or range of values), +/−1% of the stated value (or range of values), +/−2% of the stated value (or range of values), +/−5% of the stated value (or range of values), +/−10% of the stated value (or range of values), etc. Any numerical range recited herein is intended to include all sub-ranges subsumed therein.

Additionally, any method of performing the present disclosure may occur in a sequence different than those described herein. Accordingly, no sequence of the method should be read as a limitation unless explicitly stated. It is recognizable that performing some of the steps of the method in a different order could achieve a similar result.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively.

In the foregoing description, certain terms have been used for brevity, clarity, and understanding. No unnecessary limitations are to be implied therefrom beyond the requirement of the prior art because such terms are used for descriptive purposes and are intended to be broadly construed.

Moreover, the description and illustration of various embodiments of the disclosure are examples and the disclosure is not limited to the exact details shown or described.

What is claimed:

1. A wood splitting aid comprising:
a receptacle having a bottom wall and a side wall extending upwardly from the bottom wall;
an interior cavity bounded and defined by the bottom wall and the side wall, wherein the interior cavity is adapted to receive a piece of wood to be split therein; and
a resilient member provided on an upper end of the side wall of the receptacle.

2. The wood splitting aid according to claim 1, wherein said resilient member encircles an opening to the interior cavity.

3. The wood splitting aid according to claim 1, wherein the resilient member is fabricated from rubber reinforced with metal.

4. The wood splitting aid according to claim 1, wherein the side wall of the receptacle includes a lower section extending upwardly from the bottom wall, and an upper section extending upwardly from the lower section; and wherein one of the upper section and lower section is fabricated from a flexible material and the other of the upper section and lower section is fabricated from a rigid material.

5. The wood splitting aid according to claim 4, wherein the flexible material and rigid material are co-molded.

6. The wood splitting aid according to claim 1, further comprising one or more apertures defined in the side wall of the receptacle.

7. The wood splitting aid according to claim 1, further comprising a restraint adapted to secure a part of an ax handle against the resilient member.

8. The wood splitting aid according to claim 1, wherein the receptacle is an upper receptacle, and the wood splitting aid further comprises a lower receptacle positionable below the bottom wall of the upper receptacle.

9. The wood splitting aid according to claim 8, further comprising a connector assembly that secures the upper receptacle and lower receptacle to each other at least temporarily.

10. The wood splitting aid according to claim 8, further comprising a base selectively engageable with a lowermost end of the lower receptacle; wherein the base is of a greater diameter than the lowermost end of the lower receptacle.

11. The wood splitting aid according to claim 8, further comprising an adjustment base that includes:
a first base section having a side wall that tapers in height, wherein the first base section is engageable with a lowermost end of the lower receptacle, wherein the first base section is relative to the lower receptacle.

12. The wood splitting aid according to claim 11, wherein the adjustment base further comprises:
a second base section having a side wall that tapers in height; wherein the second base section is engageable with a bottom region of the first base section.

13. A method of splitting wood comprising:
providing a receptacle that defines an interior cavity;
providing a resilient member of the wood splitting aid on an upper end of the receptacle;
placing a piece of wood into a cavity bounded and defined by a side wall of the receptacle;
striking the piece of wood with a blade of a chopping tool;
splitting the piece of wood into smaller pieces of wood; and
absorbing some of a force generated by striking the piece of wood with the chopping tool with the resilient member.

14. The method according to claim 13, further comprising:
transferring some of the force generated by striking the piece of wood from the resilient member to a flexible portion of the side wall of the receptacle.

15. The method according to claim 13, further comprising:
removing bark and shards of wood generated by splitting the wood from the cavity through at least one aperture defined in a side wall of the receptacle.

16. The method according to claim 13, further comprising:
placing a section of a handle of the chopping tool on the resilient member;
wrapping a tether over a top of the handle; and
securing the tether to one of the side wall of the receptacle or to the resilient member.

17. The method according to claim 13, further comprising:
providing a lower receptacle of a wood splitting aid on a flat surface;
placing the receptacle of the wood splitting aid onto a top end of the lower receptacle such that the receptacle becomes an upper receptacle; and
transferring some of the force from the side wall of the upper receptacle to a rigid sidewall of the lower receptacle.

18. The method according to claim 17, further comprising:
engaging a connector assembly of the wood splitting aid to secure the upper receptacle and lower receptacle together.

19. The method according to claim 17, further comprising:
engaging a base with a lower end of the lower receptacle, wherein the base is of a greater diameter than the lower end of the lower receptacle; and
placing a bottom surface of the base on the flat surface; wherein the base is engaged with the lower receptacle when the flat surface is a soft surface.

20. The method according to claim 17, further comprising:
engaging a first base section of an adjustable base with a lower end of the lower receptacle;
rotating a second base section of the adjustable base relative to the first base section;
changing an angle of a bottom surface of the second base surface relative to the lower end of the lower receptacle; and
placing the bottom surface of the second base section on an inclined flat surface.
